(19) United States
(12) Patent Application Publication
(10) Pub. No.: US 2026/0339355 A1
(43) Pub. Date: Oct. 29, 2026

(54) DEVICES, SYSTEMS, AND METHODS FOR EXECUTING USER-DEFINED OBJECTIVES USING A MODULAR CLUSTER OF AUTONOMOUS VEHICLES

(71) Applicant: AI-ID, Inc., Reno, NV (US)

(72) Inventor: Shaunt M. Sarkissian, Reno, NV (US)

(73) Assignee: AI-ID, Inc., Reno, NV (US)

(21) Appl. No.: 19/187,310

(22) Filed: Apr. 23, 2025

(51) Int. Cl. G05D 1/698; B64U 20/40; B64U 101/31; G05D 1/656; G05D 109/20

(52) U.S. Cl. CPC G05D 1/6983; B64U 20/40; G05D 1/656; B64U 2101/31; B64U 2201/10; B64U 2201/20; G05D 2109/20

(57) ABSTRACT

A system for executing a user-defined objective is disclosed herein. The system can include a plurality of modular payloads and a plurality of autonomous vehicles configured to be deployed into an operating environment. The plurality of autonomous vehicles can include a first autonomous vehicle including a port electrically and mechanically couplable to each modular payload of the plurality of modular payloads. The second autonomous vehicle can be configured to establish communication with the first autonomous vehicle via a first data network, generate surveillance data associated with the operating environment and/or the first autonomous vehicle, and transmit a command to the first autonomous vehicle via the first data network. The command can be associated with the user-defined objective and the surveillance data.

### FIELD

The present disclosure is generally related to autonomous vehicles and, more particularly, is directed to the use of a modular fleet of communicatively coupled, artificially intelligent vehicles modularly configured to accommodate any of a plurality of payloads based on a user-defined objective.

### SUMMARY

In some aspects, the present disclosure is directed to a system for executing a user-defined objective. The system can include a plurality of modular payloads and a plurality of autonomous vehicles configured to be deployed into an operating environment. The plurality of autonomous vehicles can include a first autonomous vehicle including a port that is electrically and mechanically couplable to each modular payload of the plurality of modular payloads. The second autonomous vehicle can be configured to establish communication with the first autonomous vehicle via a first data network, generate surveillance data associated with the operating environment and/or the first autonomous vehicle, and transmit a command to the first autonomous vehicle via the first data network. The command can be associated with the user-defined objective and/or the surveillance data.

In other non-limiting aspects, the present disclosure is directed to a system for executing a user-defined objective. The system can include a plurality of modular payloads, wherein each modular payload of the plurality of modular payloads includes a first geometry. The system can further include an autonomous vehicle including a port that defines a cavity including a second geometry inverse to the first geometry such that each modular payload of the plurality of modular payloads can be inserted within the cavity of the port. The port can include an electrical interface configured to electrically couple each modular payload of the plurality of modular payloads to the autonomous vehicle when inserted within the cavity of the port. The port can further include a mechanical interface configured to secure each modular payload of the plurality of modular payloads to the autonomous vehicle when inserted within the cavity of the port..

In still other non-limiting aspects, the present disclosure is directed to a method of executing a user-defined objective using a modular cluster of autonomous vehicles. The method can include selecting a modular payload from a plurality of modular payloads based on the user-defined objective, electrically and mechanically coupling the modular payload selected from the plurality of modular payloads to a first autonomous vehicle via a port of the first autonomous vehicle, deploying the first autonomous vehicle and a second autonomous vehicle into an operating environment, generating a command for the first autonomous vehicle based on the user-defined objective and the modular payload selected from the plurality of modular payloads, and transmitting the command from the second autonomous vehicle to the first autonomous vehicle via a data network that communicatively couples the first autonomous vehicle to the second autonomous vehicle, wherein the command is associated with an operation of the modular payload selected from the plurality of modular payloads.

### BRIEF DESCRIPTION OF THE DRAWINGS

Various features of the aspects described herein are set forth with particularity in the appended claims. The various aspects, however, both as to organization and methods of operation, together with advantages thereof, may be understood in accordance with the following description taken in conjunction with the accompanying drawings as follows:

FIG. 1 illustrates a block diagram of a system for executing a user-defined objective using a modular cluster of autonomous vehicles, in accordance with at least one non-limiting aspect of the present disclosure;

FIG. 2 illustrates another block diagram of the system of FIG. 1, wherein an autonomous vehicle of the modular cluster of autonomous vehicles has been deployed to execute the user-defined objective, in accordance with at least one non-limiting aspect of the present disclosure;

FIG. 3 illustrates a bock diagram of various configurations for the system of FIG. 1, in accordance with at least one non-limiting aspect of the present disclosure;

FIG. 4 illustrates a perspective view of the cluster 100 of FIG. 1, in accordance with at least one non-limiting aspect of the present disclosure;

FIG. 5 illustrates a top view of the cluster of FIG. 1 is depicted, in accordance with at least one non-limiting aspect of the present disclosure;

FIGS. 6A and 6B illustrate sectioned side views of one of the autonomous vehicles of the cluster of FIG. 1, in accordance with at least one non-limiting aspect of the present disclosure;

FIGS. 7A and 7B respectively illustrate side views of two autonomous vehicles of the cluster of FIG. 1 before and after deployment, in accordance with at least one non-limiting aspect of the present disclosure;

FIG. 8 illustrates a perspective view of a first autonomous vehicle of the cluster of FIG. 1, in accordance with at least one non-limiting aspect of the present disclosure;

FIGS. 9A and 9B respectively illustrate a top and side view of the autonomous vehicle of FIG. 8, in accordance with at least one non-limiting aspect of the present disclosure;

FIG. 10 illustrates a perspective view of a second autonomous vehicle of the cluster of FIG. 1, in accordance with at least one non-limiting aspect of the present disclosure;

FIGS. 11A and 11B respectively illustrate a top and side view of the autonomous vehicle of FIG. 10, in accordance with at least one non-limiting aspect of the present disclosure;

FIG. 12 illustrates a port configured to mechanically and electrically couple any of a plurality of modular, interchangeable payloads to the vehicles of FIGS. 8 and 10, in accordance with at least one non-limiting aspect of the present disclosure;

FIGS. 13A-F illustrate several modular, interchangeable payloads configured for use with the port of FIG. 12, in accordance with at least one non-limiting aspect of the present disclosure; and

FIG. 14 illustrates a method of executing a user-defined objective using the cluster of autonomous vehicles of FIG. 1.

Corresponding reference characters indicate corresponding parts throughout the several views. The exemplifications set out herein illustrate various aspects of the invention, in one form, and such exemplifications are not to be construed as limiting the scope of the invention in any manner.

### DETAILED DESCRIPTION

Numerous specific details are set forth to provide a thorough understanding of the overall structure, function, manufacture, and use of the aspects as described in the disclosure and illustrated in the accompanying drawings. Well-known operations, components, and elements have not been described in detail so as not to obscure the aspects described in the specification. The reader will understand that the aspects described and illustrated herein are non-limiting examples, and thus it can be appreciated that the specific structural and functional details disclosed herein may be representative and illustrative. Variations and changes thereto may be made without departing from the scope of the claims. Furthermore, it is to be understood that such terms as “forward”, “rearward”, “left”, “right”, “upwardly”, “downwardly”, and the like are words of convenience and are not to be construed as limiting terms.

As used herein, a “platform” shall include an environment where software is executed. A platform can include the hardware, operating systems, and associated application programming interfaces, or other underlying software. A platform can include a control circuit (e.g., such as a processor, microprocess, or logic-based device, such as an application specific integrated circuit, as well as a memory configured to store software and/or instructions to be executed by the control circuit. A platform can provide the infrastructure and thus, foundation on which the devices, systems, and methods disclosed herein can be implemented to provide digital services, applications, and data processing functionality. It shall be appreciated that, according to some non-limiting aspects, a platform can include a client-server architecture, utilized to establish the requisite technical relationships between cooperating programs and for the deployment of a distributed application.

Before explaining various aspects of the devices, systems, and methods disclosed herein, it should be noted that the illustrative examples are not limited in application or use to the details disclosed in the accompanying drawings and description. It shall be appreciated that the illustrative examples may be implemented or incorporated in other aspects, variations, and modifications, and may be practiced or carried out in various ways. Further, unless otherwise indicated, the terms and expressions employed herein have been chosen for the purpose of describing the illustrative examples for the convenience of the reader and are not for the purpose of limitation thereof.

Autonomous vehicles, such as drones, have increased in popularity for various reasons. For example, technology has advanced such that the necessary components, such as batteries (e.g., lithium polymer, lithium ion, nickel metal hydride, nickel cadmium, etc.), motors (e.g., brushless direct current, brushed direct current, alternating current motors, etc.), global positioning system (“GPS”) components, and/or propellers have become smaller, lighter, and more affordable. These advancements have resulted in drones being more accessible and adapted for various civilian, commercial, and/or governmental applications. However, to the extent that conventional drones are implemented to accomplish user-defined objectives, such objectives tend to be limited based on the drone's particular configuration. Individual drones, for example, are restricted in terms of their payload capacity due to power and weight constraints and, therefore, are often specialized for a single purpose. Changing a payload often means a complete overhaul or replacement of the drone, which results in down time and system configurations that are retrofitted and not necessarily optimized for the new payload. The same is true for repairs, as the failure of a single component may impact other systems leading to high maintenance times and expenses. Thus, conventional drones are incapable of reconfiguration.

Accordingly, there is a need for devices, systems, and methods, for executing a user-defined objective using a modular cluster of autonomous vehicles. Such devices, systems, and methods would utilize one or more communication units configured to command, manage, and control one or more standardized vehicles with a standardized configuration modularly configured to accommodate any payload selected from a plurality of payloads. The payloads can be selected based on a objective to be performed by the standardized unit. In other words, standardized units may be selected and modularly configured such that a cluster of vehicles is specifically configured with the payloads necessary to accomplish a user-defined objective.

Some payloads may be more relevant to the user-defined objective than others and, therefore, not all of the payloads of the plurality of modular payloads may be used. The one or more communication units may be programmed to facilitate communications with and amongst the standardized vehicles and/or a ground station or Centralized Command/Control Authority (“CCA”). For example, according to one example, the one or more communication units may be controlled remotely via the CCA. However, the one or more communication units may be alternately or additionally configured to autonomously command the selected standardized units to accomplish the user-defined objective (e.g., via onboard execution of an algorithmic model, such as an artificial intelligence model). Prior to deployment, the standardized units and one or more communication units may be mechanically coupled via connective elements configured to sever upon deployment and packaged within a housing specifically configured for effective deployment. Collectively, the devices, systems and methods disclosed herein can generate and process large amounts of data and implement extensive training to ensure a cluster of autonomous vehicles accomplish a user-defined objective by enhancing contextual understanding of an operating environment and/or circumstances associated with the user-defined objective.

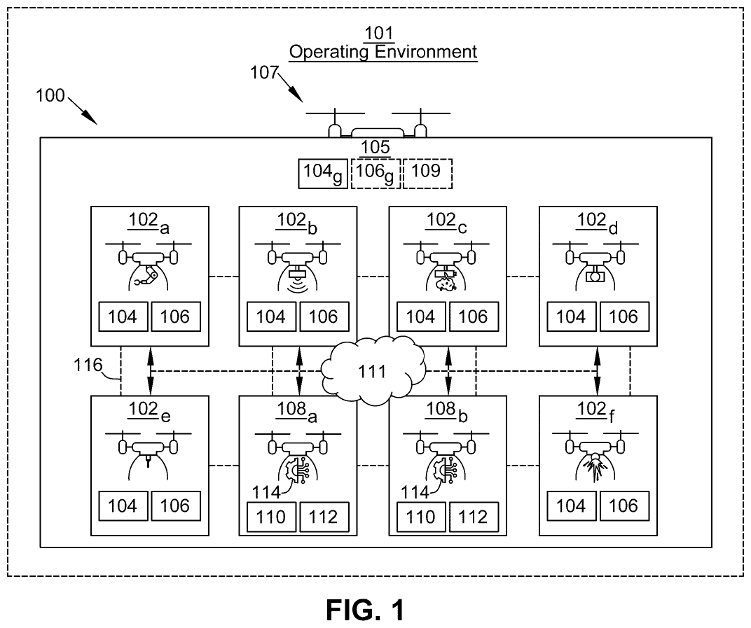

Referring now to FIG. 1, a block diagram of a system for executing a user-defined objective using a modular cluster 100 of autonomous vehicles 102_{a-f}, 108_{a,b} is depicted according to at least one non-limiting aspect of the present disclosure. According to the non-limiting aspect of FIG. 1, the cluster 100 can include a housing 105 that defines an internal cavity configured to accommodate the plurality of autonomous vehicles 102_{a-f}, 108_{a,b}. The plurality of autonomous vehicles 102_{a-f}, 108ₐ, _{b} can include one or more Modular Micro Drone Units (“MMD”) 102_{a-f} and one or more Communication Micro Drone Unit (“CMD”) 108_{a,b}. The specific functionality of the MMDs 102_{a-f} and the CMDs 108_{a,b} will be described in further detail herein.

As used herein, the term “cluster” shall include a group of two or more autonomous vehicles specifically configured and deployed to accomplish a specific, user-defined objective. For example, a cluster can include at least one MMD 102_{a-f} and at least one CMD 108_{a,b}. The cluster 100 of FIG. 1 can include six MMDs 102_{a-f} and two CMDs 108_{a,b}. However, according to other non-limiting aspects, a cluster can include any number of MMDs 102_{a-f} and/or any number of CMDs 108ₐ, 108_{b}. A cluster, for example, may be defined by the particular objective intended to be accomplished by two or more autonomous vehicles or, alternately, by the MMDs 102_{a-f} a particular CMD 108_{a,b} is configured to communicate with, manage, and/or control. For example, if a first subset of the plurality of autonomous vehicles 102_{a-c}, 108ₐ is configured to accomplish a first objective and a second subset of the plurality of autonomous vehicles 102_{d-f}, 108_{b} is configured to accomplish a second objective, the first subset of the plurality of autonomous vehicles 102_{a-c}, 108ₐ may constitute a first cluster and the second subset of the plurality of autonomous vehicles 102_{d-f}, 108_{b} may constitute a second cluster. A first CMD 108ₐ may be configured to communicate with, manage, and/or control a first subset of MMDs 102_{a-c} and a second CMD 108_{b} may be configured to communicate with, manage, and/or control a second subset of MMDs 102_{d-f}. Thus, the first CMD 108ₐ and first subset of MMDs 102_{a-c} may constitute a first cluster and the second CMD 108_{b} and second subset of MMDs 102_{d-f} may constitute a second cluster. The first CMD 108ₐ may be configured to communicate with the second CMD 108_{b}, even when deployed in separate clusters. In other words, one or more additional clusters can be deployed in conjunction with the cluster 100 of FIG. 1 to accomplish the user-defined objective, introducing a cluster-level modularity to the system.

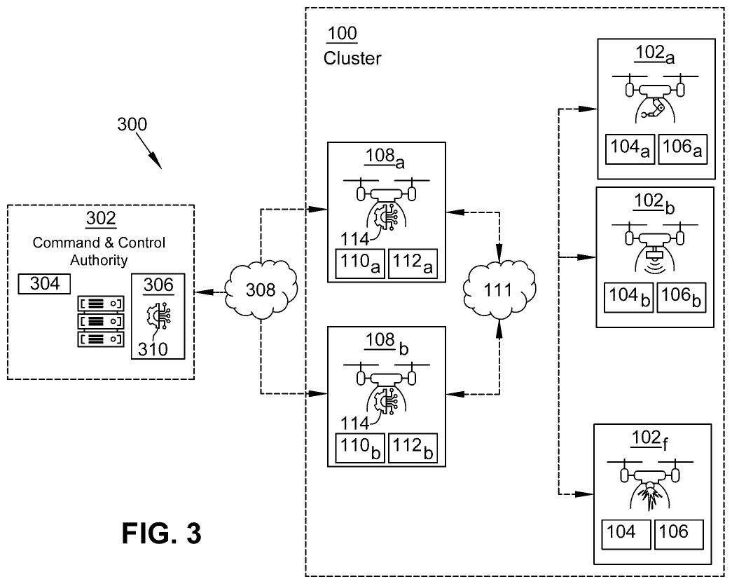

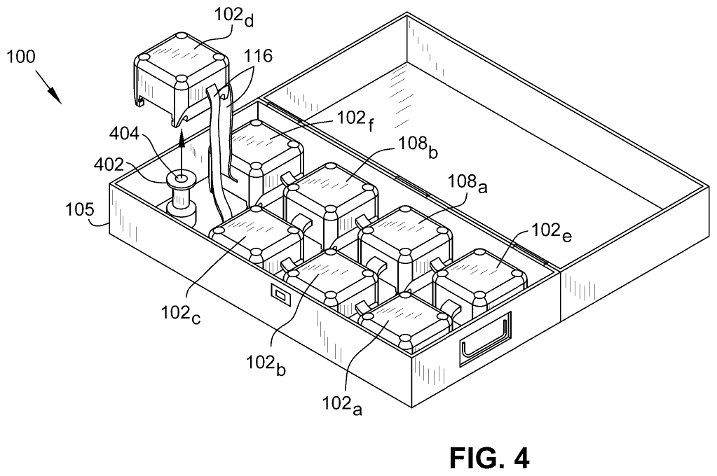

Although the housing 105 of FIG. 1 contains a single cluster 100, according to other non-limiting aspects, the housing 105 can be configured to contain two or more clusters of autonomous vehicles 102_{a-f}, 108_{a,b}. The housing 105 can be configured for manual transport from location to location throughout the operating environment 101 such as by the use of one or more handles 406 (FIG. 4) positioned on an outer surface of the housing 105. According to some non-limiting aspects, the housing 105 can include a memory 106_{g} configured to store a routing module and/or routing commands received from a remotely located computing device 302 (FIG. 3), and a control circuit 104_{g} configured to execute instructions received from the memory 106_{g} and/or the remotely located computing device (not shown). According to still other non-limiting aspects, the housing 105 can further include a propulsion system 107 configured to convey the housing 105 and the plurality of autonomous vehicles 102_{a-f}, 108_{a,b} contained therein from location to location throughout an operating environment 101 (e.g., a field, an airspace, an aquatic environment, a city, a town, a planet, space, etc.).

Still referring to FIG. 1, according to some non-limiting aspects, the housing 105 can further include a power source 109 (e.g., a battery, a capacitor, a generator, etc.) configured to power various components of the housing 105 and/or each of the plurality of autonomous vehicles 102_{a-f}, 108_{a,b} contained therein. The MMDs 102_{a-f} and CCDs 108ₐ, 108_{b} may also include their own, dedicated power sources (e.g., a battery, a capacitor, a generator, etc.), which can be electrically couplable to and configured to receive and store power from the power source 109 of the housing 105 when properly installed within the housing 105. According to some non-limiting aspects, the control circuit 104_{g} of the housing 105 can include a system-on-a-chip that includes a communications circuit configured to send and receive signals via one or more wireless protocols.

Although the housing 105 and each of the MMDs 102_{a-f} and CCDs 108ₐ, 108_{b} of FIG. 1 are exclusively configured for air-based transport, it shall be appreciated that, according to other non-limiting aspects, any of the housing 105, the MMDs 102_{a-f}, and/or the CCDs 108ₐ, 108_{b} can be alternately or additionally configured for ground-based, aquatic-based, or space-based transportation. However, as previously described, according to other non-limiting aspects, the housing 105 of the system of FIG. 1 can be alternately configured for manual transport into the operating environment 101. For example, instead of the control circuit 104_{g}, the memory 106_{g}, and/or the propulsion system 107, the housing 105 can simply include one or more handles 406 (FIG. 4).

According to still other non-limiting aspects, the housing 105 can be alternately or additionally configured for projectile-based deployments. For example, the housing 105 can define a diameter or outer perimeter at its largest point of forty millimeters, such that the housing 105 is compatible with known devices configured to launch specialized projectiles of similar dimensions (e.g., a t-shirt cannon). Projectile-based deployments can be either local or long range. Alternately, the housing 105 can be deployed from another vehicle with its own, separate propulsion system.

As depicted in FIG. 1, one or more of the plurality of autonomous vehicles 102_{a-f}, 108_{a,b} can be mechanically coupled using a plurality of connective elements 116. The connective elements 116, for example, can include break-away tethers, explosive release devices (e.g., ordinance, pyrotechnic release mechanisms, cartridge-actuated devices, propellant-actuated devices, hold-down release mechanisms, etc.), and/or non-explosive release devices (e.g., tension-based release, mechanical severing devices, electromechanical mechanisms, shape memory alloy release mechanisms, ejector release mechanisms, paraffin actuators, thermal knives, etc.), amongst others. For example, non-explosive release devices can include thermally activated release devices, such as frangibolts. The plurality of autonomous vehicles 102_{a-f}, 108_{a,b} can be arranged in a pre-configured cluster 100 based on the payloads necessary to accomplish the user-defined objective. As will be described herein, the plurality of autonomous vehicles 102_{a-f}, 108_{a,b}, can be modularly configured to accommodate any of a plurality of payloads. In other words, each of the plurality of autonomous vehicles 102_{a-f}, 108_{a,b} can be configured for electrical and mechanical coupling with each payload of a plurality of interchangeable payloads. According to such aspects, modularity can be achieved by selecting objective-relevant payloads from the plurality of interchangeable payloads and electrically and mechanically coupled to each vehicle of the plurality of autonomous vehicles 102_{a-f}, 108_{a,b}. However, according to other non-limiting aspects, at least one of the plurality of autonomous vehicles 102_{a-f}, 108_{a,b} can include an integral payload. According to such aspects, modularity can be achieved by selecting particular vehicles with objective-relevant payloads from the plurality of autonomous vehicles 102_{a-f}, 108_{a,b} to use in the cluster 100.

In further reference to FIG. 1, each autonomous vehicle of the plurality of autonomous vehicles 102_{a-f}, 108_{a,b} can include a control circuit 104 and a memory 106 configured to store instructions that, when executed by the control circuit, cause the autonomous vehicle to perform one or more of the functions and/or steps of the methods disclosed here. As depicted in FIG. 1, each autonomous vehicle of the plurality of autonomous vehicles 102_{a-f}, 108_{a,b} can be communicatively coupled to one another via a data network 111. For example, the control circuit 104 can include a system-on-a-chip that can include a communications circuit configured to send and receive signals via one or more wireless protocols. The data network 111, for example, can include a cellular network (e.g., 3G, LTE, 5G, etc.), a satellite network, a wireless infrastructure network (e.g., WiFi, WLAN, etc.), an ad hoc network (e.g., Bluetooth, NFC, Zigbee, etc.), or combinations thereof. The data network 111 may further include a private network (e.g., an intranet, etc.), a public network (e.g., the Internet, etc.), or combinations thereof.

Still referring to FIG. 1, each autonomous vehicles 102_{a-f}, 108_{a,b} of the cluster 100 can include a different payload of a plurality of payloads and can be configured to perform a specific task that is relevant to the user-defined objective. For example, the MMDs 102_{a-f} can include a port configured to mechanically and electrically couple the MMDs 102_{a-f} to each payload of a plurality of interchangeable payloads, as will be described in further detail herein. Thus, it shall be appreciate that the MMDs 102_{a-f} may include a standardized mechanical and electrical configuration and the payloads can be selected based on the user-defined objective. However, according to some aspects, at least one of the MMDs 102_{a-f} can be selected from a plurality of standardized units, each of which may have a different payload that is permanently, semi-permanently, or selectively removably coupled to the MMDs 102_{a-f}.

The plurality of standardized units can include a number of different payloads, including camera systems (e.g., RGB, thermal, infrared, multispectral) for surveillance, inspection, environmental monitoring, search and rescue, and mapping, LiDAR scanning for high-precision three-dimensional modeling, mapping, and environmental surveys, sprayers (e.g., liquid, foam, powder, etc.) for agriculture, pest control, environmental restoration, or chemical distribution, robotic arms for performing tasks like picking up, moving, or assembling objects for repair, maintenance, or construction, GPS and navigation systems for accurate positioning, geolocation, and navigation, environmental sensors (e.g., air quality, gas detection, radiation) for monitoring pollution, hazardous materials, or unsafe conditions in industrial or natural environments, destructive payloads (e.g., kinetic, non-kinetic, gaseous, sonic, electricity-generating, radiation generating, injectable, etc.), RFID tags and/or scanners for inventory management, asset tracking, and logistics operations, sound or acoustic sensors for wildlife monitoring, search and rescue, and industrial inspections, payload delivery mechanisms, for delivering packages, cargo, medical suppliers, to hard-to-reach locations, sampling equipment, hyperspectral cameras for detecting chemical signatures or materials, magnetometers for geological surveys, mapping underground structures, or detecting ferrous objects, surveying tools (e.g., tool stations, laser scanners) for surveying, construction, urban planning, wind or weather sensors for real-time weather data collection, medical payloads (e.g., needles, defibrillators, first aid kits, etc.) for emergency medical response, ground penetrating radars for subsurface investigations, communication systems for transmissions to base stations, personnel, and/or other vehicles, communication relays and/or repeaters to extend communication ranges for large area operations to maintain connectivity, lights, lasers, or beacons for visibility in low-light conditions and signaling for navigation, cargo hooks and/or drop mechanisms for large payload deliveries, thermal desorption systems to remove volatile contaminants, autonomous landing systems for precision landings, amongst other payloads that can be mixed and matched to tailor the cluster 100 to accomplish a variety of different user-defined objectives.

The number of MMDs 102_{a-f} and the specific payloads employed by each of the MMDs 102_{a-f} of the cluster 100 of FIG. 1, therefore, can be selected as necessary to accomplish the user-defined objective. For example, assume the user-defined objective involves monitoring, maintaining, and harvesting a field of agricultural crops. Accordingly, a first MMD 102ₐ may include a payload featuring a robotic arm and/or an end-effector (e.g., programmed to harvest, sample, and/or prune, etc.), a second MMD 102_{b} may include a sensing payload (e.g., a humidity sensor, etc.), a third MMD 102_{c} may include a chemical dispensing payload (e.g., fertilizer, pesticide spraying), a fourth MMD 102_{d} may include a surveillance payload (e.g., an optical sensor, a camera, a stereoscopic imaging device, a RADAR, a LiDAR, a video camera, an RGB sensor, etc.), a fifth MMD 102ₑ may include an injection and/or sampling payload (e.g., a needle configured to inject fertilizer or seeds into the soil, or withdraw a sample from the soil or plant), and/or a sixth MMD 102_{f} may include a flammable and/or a thermal dispersal payload (e.g., to perform a controlled burn on unhealthy crops and return nutrients to the soil).

According to another non-limiting example, the user-defined objective may be to administer disaster relief after a hurricane, flood, or earthquake. Thus, the cluster 100 may include the first MMD 102ₐ with the robotic arm and/or an end-effector (e.g., to move debris and/or dispense supplies), the second MMD 102_{b} with the sensing payload (e.g., a temperature sensor, a GPS sensor, and altimeter, a barometer, a gas sensor, eddy current detectors, a magnetometer, an electromagnetic radiation sensor, an acoustic sensor, humidity sensor, ground penetrating radar, thermal cameras, multispectral cameras, etc.) to characterize the operating environment 101 and/or detect harmful conditions, the third MMD 102_{c} with a payload configured to spray water or other fire suppressants (e.g., to extinguish a fire), the fourth MMD 102_{d} with a surveillance payload (e.g., to visually assess damage, identify injured citizens, generate maps, etc.), the fifth MMD 102ₑ with the injection payload (e.g., to administer medicine), and/or the sixth MMD 102_{f} with a thermal dispersion or demolition payload (e.g., to clear routes, create access, etc.).

However, different MMDs 102_{a-f} may be selected from the plurality of standardized units depending on the user-specific objective. For example, if the user-defined objective is to inspect and maintain infrastructure in an industrial environment, the cluster 100 may only include, for example, the first MMD 102ₐ with the robotic arm and/or an end-effector (e.g., to test the infrastructure, to maintain the infrastructure, to move obstacles, to take samples, etc.), the second MMD 102_{b} with the sensing payload (e.g., to inspect the infrastructure), and/or the fourth MMD 102_{d} with the surveillance payload (e.g., to image the infrastructure). Thus, according to this example, the cluster 100 does not include the third MMD 102_{c}, the fifth MMD 102ₑ, and the sixth MMD 102_{f}, which have payloads that are irrelevant to the user-defined objective. This reduces the power and weight of the cluster 100, providing a technological advantage. However, the housing 105 remains mechanically and electrically compatible with the third MMD 102_{c}, the fifth MMD 102ₑ, and the sixth MMD 102_{f}. Similarly, the CMDs 108a, 108b remain communicatively compatible with the third MMD 102_{c}, the fifth MMD 102ₑ, and the sixth MMD 102_{f}. Thus, it shall be appreciated that the cluster 100 can be alternately configured to include any combination of MMDs 102_{a-f} and deployed to accomplish different user-defined objectives in the future.

Aside from the payloads, the MMDs 102_{a-f} can further include one or more optical sensors (e.g., pinhole cameras) integrated into their hulls in tactical positions. For example, as will be described in further detail herein, each of the MMDs 102_{a-f} can include four optical sensors configured to generate sensor/image data associated with the MMDs 102_{a-f}, the surroundings of the MMDs 102_{a-f}, and/or the operating environment 101. This image data can be transmitted to the CMDs 108a, 108b and/or base station and processed to generate contextual insights about the current position of the MMDs 102_{a-f}. Such insights can be utilized to alter operation of the MMDs 102_{a-f}.

Still referring to FIG. 1, each of the MMDs 102_{a-f} may be configured to communicate with each other and with each of the CMDs 108ₐ, 108_{b} via the data network 111. According to one non-limiting aspect, the data network 111 may include a short range, local, or ad hoc network (e.g., Bluetooth, encrypted radio frequencies, Zigbee, direct line of sight communications, near field communications, RFID, etc.) configured for shorter range communications. However, the CMDs 108ₐ, 108_{b} may be additionally configured to communicate with a base station via a long range, infrastructure network, such as a cellular network (e.g., 3G, LTE, 5G, etc.), a satellite network, and/or a wireless infrastructure network (e.g., WiFi, WLAN, etc.). Thus, the cluster 100 can establish a uniquely configured mesh network capable of intra-cluster and extra-cluster communications, in some instances, via the CMDs 108ₐ, 108_{b}. According to some non-limiting aspects, the cluster 100 of FIG. 1 can communicate with the CMDs 108ₐ, 108_{b} of another cluster via short range or long range network for multi-cluster operations to accomplish multiple, interrelated objectives.

Communications between the MMDs 102_{a-f} and the CMDs 108ₐ, 108_{b} of the cluster 100 of FIG. 1 may be secured to ensure confidentiality and prevent interference from third parties. For example, cryptographic protocols can be used to ensure data being transmitted between the base station and the CMDs 108ₐ, 108_{b}, the CMDs 108ₐ, 108_{b} and the MMDs 102_{a-f}, and the MMDs 102_{a-f} themselves are secure and private. For short-range networks, a communication range may generally be limited to a few hundred meters and, therefore, Advanced Encryption Standard (“AES”), Secure Socket Layer (“SSL”), and/or Virtual Private Networks (“VPNs”) may be appropriate. Alternately, a secure pairing technique requiring a passkey entry may be implanted to establish the shortrange network. For longer range networks, end-to-end encryption, VPN over cellular, AES, Public Key Infrastructure (“PKI”), and/o other means of encrypting communications at the network level may be implemented to secure communications. According to some non-limiting aspects, alternate, more secure encryption techniques may be implemented, such as AES-256, elliptic curve digital signature algorithms, elliptic curve Diffie-Hillman algorithms, type 1 encryptors, key management infrastructure, Galois/Counter Mode-AES, single channel ground and airborne radio systems, joint tactical radio systems, and/or Secure Hash Algorithm-2, may be used, amongst other techniques that comply with relevant standards (e.g., MIL-STD-810G, MIL-STD-461, etc.).

Each of the MMDs 102_{a-f} of the system 100 of FIG. 1 may include a control circuit 104_{a-f} and a memory 106_{a-f} configured to store instructions that, when executed by the control circuit 104_{a-f} cause the MMDs 102_{a-f} to perform the functionality and methods attributed to them, as disclosed herein. For example, the memory 106_{a-f} of each of the MMDs 102_{a-f} may store instructions that, when executed by the control circuit 104_{a-f} cause the MMDs 102_{a-f} to deploy from the housing 105, sever one or more connective elements 116, communicate with the CMDs 108ₐ, 108_{b} and other MMDs 102_{a-f} of the cluster 100, and/or use their respective payloads in accordance with store instructions or received commands. According to some non-limiting aspects, the instructions stored in the memory 106_{a-f} of each of the MMDs 102_{a-f} may be provided, altered, monitored, or managed via commands transmitted by one or more of the CMDs 108ₐ, 108_{b}. Each of the CMDs 108ₐ, 108_{b} can also include a control circuit 110ₐ, 110_{b} and a memory 112ₐ, 112_{b} that stores instructions that, when executed by the control circuit 110ₐ, 110_{b} cause the MMDs 102_{a-f} to perform the functionality and methods attributed to them, as disclosed herein. However, according to some non-limiting aspects, the control circuits 110ₐ, 110_{b} and memories 112ₐ, 112_{b} used by the CMDs 108ₐ, 108_{b} may be different and more powerful than the control circuits 104_{a-f} and a memories 106_{a-f} of the MMDs 102_{a-f}. For example, the control circuits 110ₐ, 110_{b} of the CMDs 108ₐ, 108_{b} may include graphic processing units (GPUs), tensor processing units (TPUs), neural processing units (NPUs), and/or Field Programable Gate Arrays (FPGAs), amongst others. This is because instructions stored in the memories 112ₐ, 112_{b} of the CMDs 108ₐ, 108_{b} may be more resource intensive to process since the functionality attributed to the CMDs 108ₐ, 108_{b} is typically more substantial than the functionality of the MMDs 102_{a-f}. For example, the CMDs 108ₐ, 108_{b} may be responsible for communicatively coupling the cluster 100 to the base station and, therefore, may require more software and hardware capable of facilitating longer-range transmissions and more secure encryption than the MMDs 102_{a-f}.

According to some non-limiting aspects, the CMDs 108ₐ, 108_{b} of the system 100 of FIG. 1 may have more surveillance functionality and/or hardware and stronger hulls than the MMDs 102_{a-f}. For example, the CMDs 108ₐ, 108_{b} may have eight or more optical sensors configured to generate image data associated with the surroundings of the CMDs 108ₐ, 108_{b}. The control circuits 110ₐ, 110_{b} of the CMDs 108ₐ, 108_{b} (or a base station) may be further configured to process (e.g., stitch together) image data generated by the optical sensors of the CMDs 108ₐ, 108_{b} and/or MMDs 102_{a-f}, thereby providing cluster 100 level contextual insights, informing a user as to the relative position and surroundings of each of the MMDs 102_{a-f} and CMDs 108ₐ, 108_{b} of the cluster 100. Thus, it shall be appreciated that the configuration of each of the CMDs 108ₐ, 108_{b} can be specifically altered relative to the MMDs 102_{a-f} based on the size of the cluster 100, specific payloads, and user-defined objective to balance the overall weight, power, and structural requirements of the cluster 100.

According to some non-limiting aspects, the CMDs 108ₐ, 108_{b} of the cluster 100 of FIG. 1 may not have a payload, which can offset any additional weight resulting from the control circuits 110ₐ, 110_{b} and memories 112ₐ, 112_{b}, hulls, and enhanced surveillance hardware. However, according to other non-limiting aspects, one or more of the CMDs 108ₐ, 108_{b} may further include one or more of the aforementioned payloads. For example, one or more of the CMDs 108ₐ, 108_{b} may include a port configured to mechanically and electrically couple any payload from the plurality of payloads described herein. According to some non-limiting aspects, one or more of the MMDs 102_{a-f} of the cluster 100 of FIG. 1 may not have a payload and may be exclusively configured to relay signals as part of a mesh network.

The cluster 100 of FIG. 1 can operate in response to a Modular Micro Cluster Drone (“MMCD”) model 114. As depicted in FIG. 1, the MMCD model 114 can be stored in the memories 112ₐ, 112_{b} of the CMDs 108ₐ, 108_{b} and executed by the control circuits 110ₐ, 110_{b} of the CMDs 108ₐ, 108_{b}. However, according to other non-limiting aspects, the MMCD model 114 may be stored in a memory 306 (FIG. 3) and executed by a control circuit 304 (FIG. 3) of a computing device positioned in a base station or a CCA 302 (FIG. 3). In other words, the MMDs 102_{a-f} and CMDs 108ₐ, 108_{b} may be controlled remotely via the CCA 302 (FIG. 3). In response to the MMCD model 114, the CMDs 108ₐ, 108_{b} may autonomously command the MMDs 102_{a-f} to accomplish the user-defined objective. The MMCD model 114 can be configured to establish direct communication with and between the CCA 302 (FIG. 3) and the CMDs 108ₐ, 108_{b}, which may be configured to function s a localized communication link to the MMDs 102_{a-f} of the cluster 100. Prior to deployment, the CMDs 108ₐ, 108_{b} may be configured to execute an MMCD model 114 and/or integrate with a CCA 302 (FIG. 3) that hosts the MMCD model 114, thereby ensuring the MMDs 102_{a-f}, CMDs 108ₐ, 108_{b}, and/or CCA are properly configured for cluster 100 communication. According to some non-limiting aspects, the CMDs 108ₐ, 108_{b} and/or CCA 302 (FIG. 3) may be additionally configured to communicate with other clusters, which may employ a different permutation of MMDs 102_{a-f} with different payloads to accomplish different user-defined objectives, for larger scale operations.

According to some non-limiting aspects, the MMCD model 114 may include an artificial intelligence generated machine executable (“AGMX”) functionality, similar to the models disclosed in U.S. patent application Ser. No. 18/792,290, titled DEVICES, SYSTEMS, AND METHODS FOR AUTONOMOUSLY GENERATING AND IMPLEMENTING MACHINE EXECUTABLE FILES, and filed on Aug. 1, 2024, the disclosure of which is incorporated by reference in its entirety herein. Specifically, the AGMX platform 102 can include an artificial intelligence model configured to generate and transmit AGMX files that includes instructions to be executed by one or more of the CMDs 108ₐ, 108_{b} and/or MMDs 102_{a-f} of the cluster 100, subject to a risk management model. For example, a risk management model can be stored in the memory 106_{g} of the housing 105, the memory 306 (FIG. 3) of the CCA 302 (FIG. 3), or one of the memories 112ₐ, 112_{b} of a CMDs 108ₐ, 108_{b} that does not store the MMCD model 114. When executed by a corresponding control circuit, the risk management model can be configured to receive sensor feedback from the CMDs 108ₐ, 108_{b} and/or MMDs 102_{a-f} via the data network 111 and can generate and transmit monitoring commands that one or more of the CMDs 108ₐ, 108_{b} and/or MMDs 102_{a-f} of must adhere to, thereby ensuring compliant completion of the user-defined objective. Monitoring commands, for example, may be configured to alter operation of one or more of the CMDs 108ₐ, 108_{b} and/or MMDs 102_{a-f}, terminate operation of one or more of the CMDs 108ₐ, 108_{b} and/or MMDs 102_{a-f}, alter a path of traversal of one or more of the CMDs 108ₐ, 108_{b} and/or MMDs 102_{a-f}, and/or partially disable functionality (e.g., of a sensor or payload, of a propulsion system, etc.)) of one or more of the CMDs 108ₐ, 108_{b} and/or MMDs 102_{a-f}, amongst other monitoring commands. The risk management model can be a module separate from the MMCD model 114 or stored and executed by a separate computing device (e.g., the CCA and/or the control circuit 104_{g} and memory 106_{g} of the housing 105, assuming one or more CMDs 108ₐ, 108_{b} store and execute the MMCD model 114) to ensure the risk management model runs without bias from the MMCD model 114.

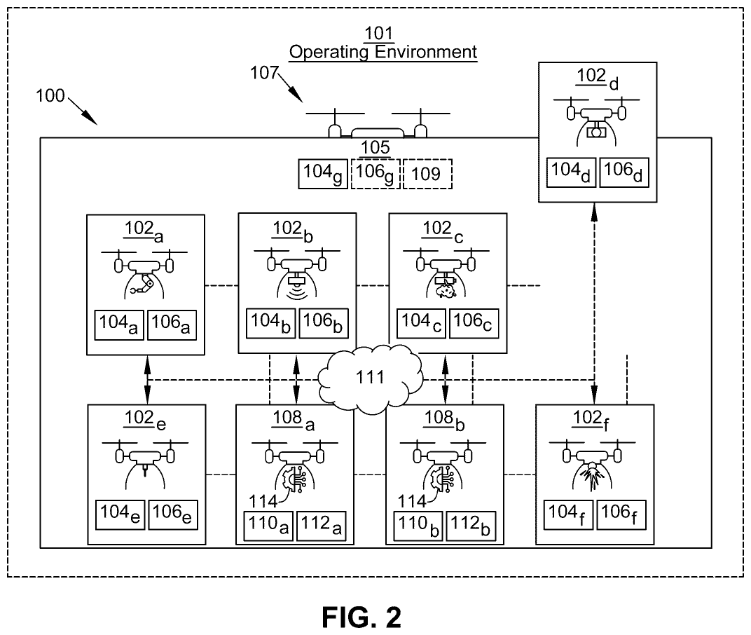

Referring now to FIG. 2, another block diagram of the system of FIG. 1 is depicted, wherein an MMD 102_{d} of the plurality of MMDs 102_{a-f} has been deployed from the cluster 100 into the operating environment 101. According to the non-limiting aspect of FIG. 2, the fourth MMD 102_{d} with the surveillance payload (e.g., an optical sensor, a camera, a stereoscopic imaging device, a RADAR, a LiDAR, a video camera, an RGB sensor, etc.), has been deployed from the housing 105 into the operating environment 101. As will be described in further detail herein, the housing can include a deployment mechanism configured to deploy each of the CMDs 108ₐ, 108_{b} and MMDs 102_{a-f} either individually at different times or collectively at the same time.

In further reference to FIG. 2, the connective elements 106 that, as depicted in FIG. 1, previously mechanically coupled the fourth MMD 102_{d} to the third MMD 102_{c} and fifth MMD 102ₑ has been separated, which mechanically releases the fourth MMD 102_{d} from the third MMD 102_{c} and the fifth MMD 102ₑ. If the connective elements 106 included break-away tethers, such tethers have been severed. If the connective elements 106 included explosive or non-explosive release devices, such releases devices have been activated. According to some non-limiting aspects, separation of one or more of the connective elements 106 can be performed in coordination with activation of the deployment mechanism. Separation of the connective elements 106 and/or activation of the deployment mechanism can be initiated via the control circuit 104_{g} of the housing 105, the control circuits 110ₐ, 110_{b} of the CMDs 108ₐ, 108_{b}, or a control circuit 304 (FIG. 3) of the CCA 302 (FIG. 3) depending on the specific configuration of the cluster 100 employed by the user. Regardless, FIG. 2 further depicts how the fourth MMD 102_{d} remains communicatively coupled to the CMDs 108ₐ, 108_{b} and, therefore, the other MMDs 102_{a-c, e-f}. According to the non-limiting aspect wherein the housing 105 includes a central power source 109, upon deployment, the fourth MMD 102_{d} has been decoupled from the central power source 109 of the housing 105 and is being powered by its own, dedicated power source (e.g., a battery, a capacitor, a generator, etc.) (not shown).

Referring now to FIG. 3, a bock diagram of several potential configurations of the cluster 100 of FIG. 1 is depicted according to at least one non-limiting aspect of the present disclosure. According to the non-limiting aspect of FIG. 3, the cluster 100 (FIG. 1) can be configured such that the CCA 302 is communicatively coupled to the CMDs 108ₐ, 108_{b} via a long range network 308, such as a cellular network (e.g., 3G, LTE, 5G, etc.), a satellite network, and/or a wireless infrastructure data network (e.g., WiFi, WLAN, etc.). The CMDs 108ₐ, 108_{b}, however, can be communicatively coupled to the MMDs 102_{a-f} via a local, short range data network 111 (e.g., Bluetooth, encrypted radio frequencies, Zigbee, direct line of sight communications, etc.). Collectively, the CMDs 108ₐ, 108_{b} and MMDs 102_{a-f} establish a mesh network.

Still referring to FIG. 3, according to one non-limiting aspects, the MMCD model 114 can be stored in the memories 112ₐ, 112_{b} of the CMDs 108ₐ, 108_{b} and executed by the control circuits 110ₐ, 110_{b} of the CMDs 108ₐ, 108_{b}. In other words, according to the non-limiting aspect of FIG. 3, the CMDs 108ₐ, 108_{b} can be configured to generate commands that either control the MMDs 102_{a-f} and/or are executable by each of the MMDs 102_{a-f} for autonomous control. In other words, the CMDs 108ₐ, 108_{b} of the can be configured to control the cluster 100 via the short range data network 111. In such a configuration, the CMDs 108ₐ, 108_{b} can transmit data (e.g., surveillance data generated by the CMDs 108ₐ, 108_{b}, telemetry, image data, sensor data, etc.) back to the CCA 302 for review and/or processing via the long range 308 data network. However, according to other non-limiting aspects, the MMCD model 114 may be stored in a memory 306 and executed by a control circuit 304 of a computing device positioned in a base station or a CCA 302. In other words, the MMDs 102_{a-f} and CMDs 108ₐ, 108_{b} may be controlled remotely via the CCA 302.

According to some non-limiting aspects, it may be preferable for the configuration 300 of FIG. 3 to initially use two or more CMDs 108ₐ, 108_{b} to store and execute the MMCD model 114 in case one of the CMDs 108ₐ, 108_{b} experiences a technical difficulty or is otherwise incapacitated. Accordingly, control of the cluster 100 can be maintained during unforeseen circumstances. According to some non-limiting aspects, a CCA model 310 may be stored in a memory 306 and executed by a control circuit 304 of a computing device of the CCA 302. The CCA model 310 can be configured to function as one of the CMDs 108ₐ, 108_{b} the MMCD model 114 via the long range network 308. In other words, the CCA model 310 may be configured to function as a contingency to the MMCD model 114, when the configuration 300 primarily relies on the CMDs 108ₐ, 108_{b} to store and execute the MMCD model 114. For example, if the CCA model 310 has not received expected data (e.g., a status signal, telemetry, image data, sensor data, etc.) from the CMDs 108ₐ, 108_{b} within a predefined interval (e.g., one minute, five minutes, ten minutes, etc.) the CCA model 310 may be configured to function as the MMCD model 114 and control the cluster 100.

Alternately or additionally, the configuration 300 of FIG. 3 can utilize the CCA model 310 as a risk management model, configured to receive sensor feedback from the CMDs 108ₐ, 108_{b} and/or MMDs 102_{a-f} via the long range data network 308 and generate and transmit monitoring commands that one or more of the CMDs 108ₐ, 108_{b} and/or MMDs 102_{a-f} of must adhere to, thereby ensuring compliant completion of the user-defined objective. For example, the CCA model 310 can include a risk management model similar to those disclosed in U.S. patent application Ser. No. 18/792,290, titled DEVICES, SYSTEMS, AND METHODS FOR AUTONOMOUSLY GENERATING AND IMPLEMENTING MACHINE EXECUTABLE FILES, and filed on Aug. 1, 2024, the disclosure of which is incorporated by reference in its entirety herein. Such a configuration can ensure that compliance of the CMDs 108ₐ, 108_{b} and/or MMDs 102_{a-f} of the cluster 100 is be managed in an unbiased manner.

According to other non-limiting aspects, the configuration 300 of FIG. 3 can be configured to initially utilize the CCA model 310 stored in the memory 306 and executed by the control circuit 304 of the computing device associated with the CCA 302 as the MMCD model 114. The CCA model 310 can be initially configured to generate commands that either control the CMDs 108ₐ, 108_{b} and MMDs 102_{a-f} and/or are executable by each of the CMDs 108ₐ, 108_{b} and MMDs 102_{a-f} for autonomous control. In other words, the CCA model 310 can be configured to control the cluster 100 via the long range data network 308. Accordingly, the MMCD model 114 of the CMDs 108ₐ, 108_{b}, therefore, can be configured to receive commands from the CCA model 310 via the long range data network 308 and, if authorized by the CCA model 310, attenuate the commands based on sensor data (e.g., surveillance data generated by the CMDs 108ₐ and/or 108_{b}, data received from the MMDs 102_{a-f}, data or instructions received from the CCA, etc.). Thus, the MMCD model 114 may cause the CMDs 108ₐ, 108_{b} to distribute such commands to the MMDs 102_{a-f} via the short range data network 111. In other words, commands can be updated in real-time based on activity and/or conditions of the cluster 100 and/or operating environment 101 (FIGS. 1 and 2). This can enhance responsiveness and ensure the user-defined objective is accomplished.

According to some non-limiting aspects, the MMCD models 114 may be configured to function as a contingency to the CCA model 310, when the configuration 300 primarily relies on the CCA 302 to store and execute the CCA model 310. According to such aspects, a first CMD 108ₐ may be configured to receive, attenuate and transmit commands from the CCA 302 to the MMDs 102_{a-f} and a second CMD 108_{b} may be configured to store and execute a risk management model to ensure compliance of the first CMD 108ₐ and/or MMDs 102_{a-f} on behalf of the CCA model 310.

Referring now to FIG. 4, a perspective view of the cluster 100 of FIG. 1 is depicted according to at least one non-limiting aspect of the present disclosure. According to the non-limiting aspect of FIG. 4, the housing 105 can include deployment mechanisms 402 configured to deploy each of the CMDs 108ₐ, 108_{b} and MMDs 102_{a-f}. Although a single deployment mechanism 402 corresponding to the fourth MMD 102_{d} is depicted in FIG. 4, it shall be appreciated that the housing 105 includes similar deployment mechanisms 402 positioned beneath each of the CMDs 108ₐ, 108_{b} and MMDs 102_{a-f} such that all of the CMDs 108ₐ, 108_{b} and MMDs 102_{a-f} can be deployed from the housing 105 upon manual activation or receipt of a signal from the housing 105, the CMDs 108ₐ, 108_{b}, or the CCA 302 (FIG. 3). The deployment mechanisms 402 of the housing 105 can be configured either for individual or collective activation. For example, according to some non-limiting aspects, all of the deployment mechanisms 402 can be simultaneously activated such that all of the CMDs 108ₐ, 108_{b} and MMDs 102_{a-f} are deployed at once. However, according to other non-limiting aspects, one or more of the deployment mechanisms 402 can be sequentially activated such that one or more of the corresponding CMDs 108ₐ, 108_{b} and MMDs 102_{a-f} are deployed in accordance with a predefined sequence.

In further reference to FIG. 4, each of the deployment mechanisms 402 may have an interface 404. For example, the interface 404 may be configured to mechanically and/or electrically couple the CMDs 108ₐ, 108_{b} and MMDs 102_{a-f} to the housing 105 prior to deployment. For example, the interface 404 can ensure that the CMDs 108ₐ, 108_{b} and MMDs 102_{a-f} are secured within the housing 105 and protected from undesirable contact during transport prior to deployment. According to some non-limiting aspects, the CMDs 108ₐ, 108_{b} and MMDs 102_{a-f} can receive electrical signals via the interface 404, such as power from the power source 109 (FIG. 1) of the housing or signals (e.g., programming, commands, firmware updates, etc.) from the housing 105, the CMDs 108ₐ, 108_{b}, or the CCA 302 (FIG. 3) prior to deployment. Although the housing 105 of FIG. 4 is configured to accommodate a total of eight CMDs 108ₐ, 108_{b} and MMDs 102_{a-f}, according to other non-limiting aspects, the housing 105 can be alternately configured to accommodate any number of CMDs 108ₐ, 108_{b} and MMDs 102_{a-f}. Additionally, portions of the housing 105 can include a cushioned material, a heat resistant material, a thermally resistant material, a floating material, and/or a radiation hardened material amongst others.

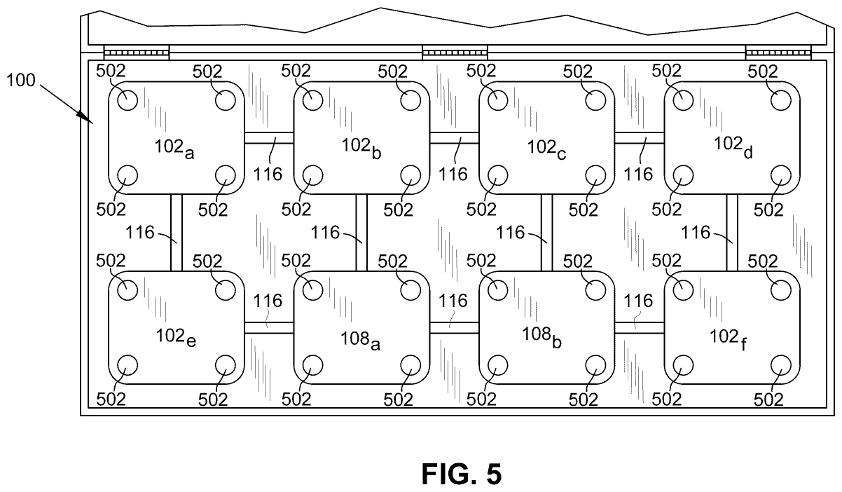

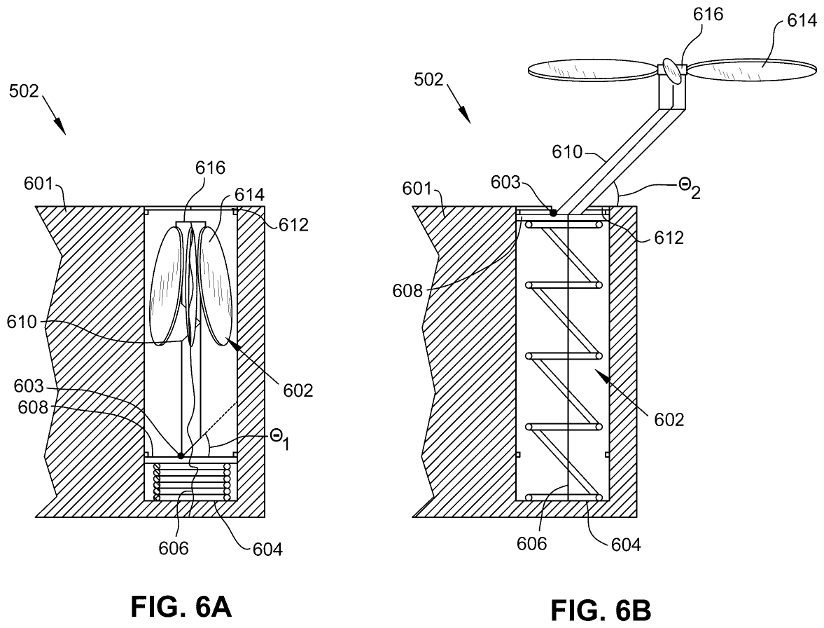

Referring now to FIG. 5, a top view of the cluster 100 of FIG. 1 is depicted according to at least one non-limiting aspect of the present disclosure. According to the non-limiting aspect of FIG. 5, each of the CMDs 108ₐ, 108_{b} and MMDs 102_{a-f} can include at least one propulsion system 502. For example, each of the CMDs 108ₐ, 108_{b} and MMDs 102_{a-f} can include four propulsion systems 502 each of which can positioned in a corner of the CMDs 108ₐ, 108_{b} and MMDs 102_{a-f}. It shall be appreciated that such a configuration can be used to distribute the weight of each of the CMDs 108ₐ, 108_{b} and MMDs 102_{a-f} across each of the propulsion systems 502. However, according to other non-limiting aspects, at least one of the CMDs 108ₐ, 108_{b} or MMDs 102_{a-f} can have as little as one propulsion system 502 configured to sustain the weight of its respective CMD 108ₐ, 108_{b} or MMD 102_{a-f}. As will be described in further detail with reference to FIGS. 6A and 6B, the propulsion systems 502 are stowed because, according to FIG. 5, none of the CMDs 108ₐ, 108_{b} or MMDs 102_{a-f} have been deployed from the housing 105. Likewise, according to FIG. 5, the connective elements 116 are depicted intact. However, upon deployment, each connective element 116 mechanically coupling the CMDs 108ₐ, 108_{b} and MMDs 102_{a-f} of the cluster 100 will be severed, allowing each of the CMDs 108ₐ, 108_{b} and MMDs 102_{a-f} of the cluster 100 to traverse an operating environment 101 (FIG. 1) independent of one another via the propulsion systems 502.

Referring now to FIGS. 6A and 6B, sectioned side views of any of the CMDs 108ₐ, 108_{b} or MMDs 102_{a-f} (FIGS. 1-5) of the cluster 100 of FIG. 1 (FIGS. 1-5) are depicted according to at least one non-limiting aspect of the present disclosure. Specifically, FIG. 6A depicts a propulsion system 502 of the CMDs 108ₐ, 108_{b} and MMDs 102_{a-f} (FIGS. 1-5) in a stowed condition and FIG. 6B depicts the propulsion system 502 of the CMDs 108ₐ, 108_{b} and MMDs 102_{a-f} (FIGS. 1-5) in an activated condition. Although the propulsion system 502 of FIGS. 6A and 6B is specifically configured for air-based travel, it shall be appreciated that, according to other non-limiting aspects, the propulsion system 502 can be alternately configured for water-based, space-based, or ground-based travel.

In further reference to FIG. 6A, a body 601 of the CMDs 108ₐ, 108_{b} and MMDs 102_{a-f} (FIGS. 1-5) can define an internal cavity 602 configured to accommodate a spring member 604 and a propeller 614. The spring member 604 can transition between a stressed condition, as depicted in FIG. 6A and a biased or extended position, as depicted in FIG. 6B. The propeller 614 can be mechanically coupled to a motor 616 at the end of a shaft 610, which can be mechanically coupled to a base member 608 via a hinge 603. The base member 608 can provide a solid surface configured to compress the spring member 604 into a stressed condition when the propeller 614 is properly stowed within the internal cavity 602. The base member 608, for example, can prevent the spring member 604 from transitioning from the stressed condition to the biased or extended position by one or more blocking members 607. The one or more blocking members 607 can be retracted upon deployment, allowing the base member 608 to pass such that the spring member 604 can transition to the biased or extended position as depicted in FIG. 6B. In the biased or extended position, the base member 608 can be blocked by one or more gates 612. Additionally, the blades of the propeller 614 can be biased by a spring in the extended position. However, when stowed within the internal cavity 602, the blades of the propeller 614 may be compressed towards the shaft 610. Upon activation, the spring bias may cause the blades of the propeller 614 to return to the extended position for rotation via the motor 616. Additionally, a cable 606 can be mechanically coupled to a base of the body 601 of the CMDs 108ₐ, 108_{b} and MMDs 102_{a-f} (FIGS. 1-5), traversing through a hole defined by the spring member 604 and through a hollow cavity of the shaft 610. Notably, a bottom surface of the shaft 610 defines a first angle θ₁ relative to the substantially flat top surface of the base member 608. The cable 606 can be mechanically coupled to motor 616 at the end of a shaft 610. As depicted in FIG. 6A, when the propulsion system 502 is stowed and the spring member 604 is in the stressed condition and retained by the one or more blocking members 607, the cable 606 has slack.

However, referring to FIG. 6B, the propulsion system 502 of the CMDs 108ₐ, 108_{b} and MMDs 102_{a-f} (FIGS. 1-5) has been activated. The one or more blocking members 607 have been retracted, which has allowed the spring member 604 to return to its biased condition, pushing the base member 608 to the top of the internal cavity 602 defined by the body 601 of the CMDs 108ₐ, 108_{b} and MMDs 102_{a-f} (FIGS. 1-5), where it is blocked by the one or more gates 612, which ensures proper positioning of the shaft 610, propeller 614, and motor 616. However, according to other non-limiting aspects, other blocking members can be included within the internal cavity 602 to ensure proper positioning of the shaft 610, propeller 614, and motor 616.

Still referring to FIG. 6B, as the spring member 604 pushes the base member 608 to the top of the internal cavity 602, the cable 606 remains anchored to the base of the body 601. Accordingly, as the propulsion system 502 is activated, the motor 616 pulls the cable 606 up, eliminating the slack depicted in FIG. 6A. In FIG. 6B, it is evident that a tension has been created within the cable 606 between the motor 616 and the base of the body 61, which causes the shaft down 610 to pivot about the hinge 603 until a bottom surface of the shaft 610 is flush with the substantially flat top surface of the base member 608. Thus, in the activated condition, the cable 606 causes the shaft 610 itself to define a second angle θ₂ relative to the substantially flat top surface of the base member 608. According to some non-limiting aspects, the first angle θ₁ is the same as the second angle θ₂. In this way, an angled propulsion system 502 can be compactly and discretely stowed within the CMDs 108ₐ, 108_{b} and MMDs 102_{a-f} (FIGS. 1-5) until deployed from the housing 105 (FIGS. 1-5). According to some non-limiting aspects, a similar hinge and angle configuration can be deployed on the shaft 610 just below the motor 616 to ensure proper positioning of the propellers upon activation (e.g., sufficiently parallel to a top surface of the CMDs 108ₐ, 108_{b} and MMDs 102_{a-f} (FIGS. 1-5).

According to some non-limiting aspects, the cable 606 can be further configured as an electrical conduit providing electrical power from a power source of the CMDs 108ₐ, 108_{b} and MMDs 102_{a-f} (FIGS. 1-5) to the motor 616. Thus, once deployed, the propulsion system 502 can rotate the propeller 614 via electrical power provided to the motor 616, thereby propelling the CMDs 108ₐ, 108_{b} and MMDs 102_{a-f} (FIGS. 1-5) through the operating environment 101 (FIGS. 1 and 2). According to some non-limiting aspects, the motor 616 can include an actuator configured to further angle the propeller 614 for additional steering, precision, and control of the CMDs 108ₐ, 108_{b} and MMDs 102_{a-f} (FIGS. 1-5).

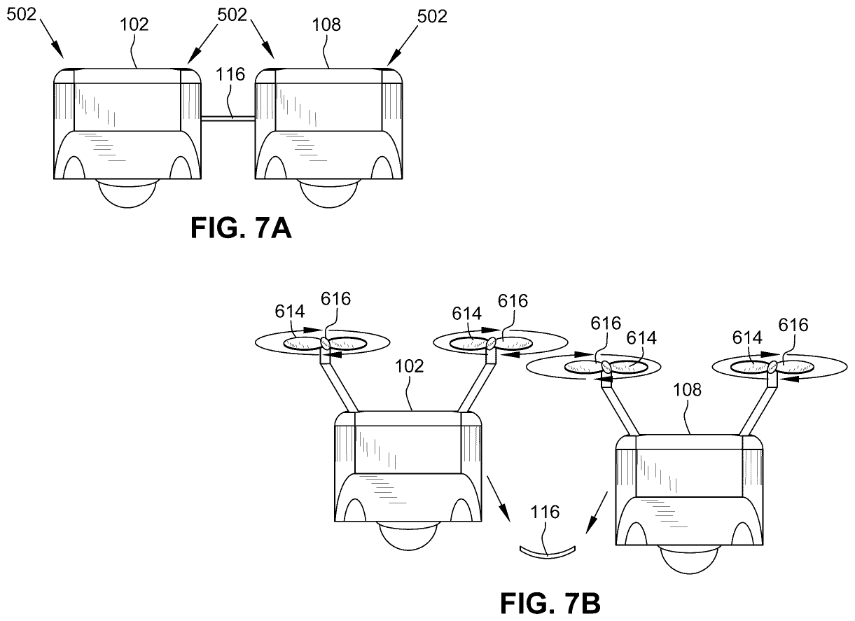

Referring now to FIGS. 7A and 7B, side views of a CMD 108 and an MMD 102 of the cluster 100 of FIG. 1 (FIGS. 1-5) before and after deployment are depicted according to at least one non-limiting aspect of the present disclosure. For example, FIG. 7A depicts the CMD 108 and the MMD 102 prior to deployment. Accordingly, the propulsion systems 502 of both of the CMD 108 and the MMD 102 are stowed and the CMD 108 is mechanically coupled to the MMD 102 via the connective element 116, which remains intact. However, according to FIG. 7B, both of the CMD 108 and the MMD 102 have been deployed and, therefore, the propulsion systems 502 have been activated. Thus, the shaft 610, the propeller 614, and the motor 616 are outside of the body of the CMD 108 and the MMD 102, with the shafts 610 of the propulsion system 502 properly positioned at the second angle θ₂ (FIGS. 6A and 6B). According to FIG. 7B, the propellers 614 are rotating via electrical power provided to the motor 616.

In further reference to FIG. 7B, the connective element 116 between the CMD 108 and the MMD 102. According to the non-limiting aspect wherein the connective element 116 includes a break-away tether, the tether has broken. According to the non-limiting aspect wherein the connective element 116 includes an explosive release device, the release devices has been detonated. According to the non-limiting aspect wherein the connective element 116 includes a non-explosive release devices mechanical, thermal, or electrical energy has caused the connective element 116 to release from the CMD 108 and the MMD 102. Accordingly, the CMD 108 and the MMD 102 are free to traverse the operating environment 101 (FIGS. 1 and 2) and perform their respective tasks relative to the user-defined objective.

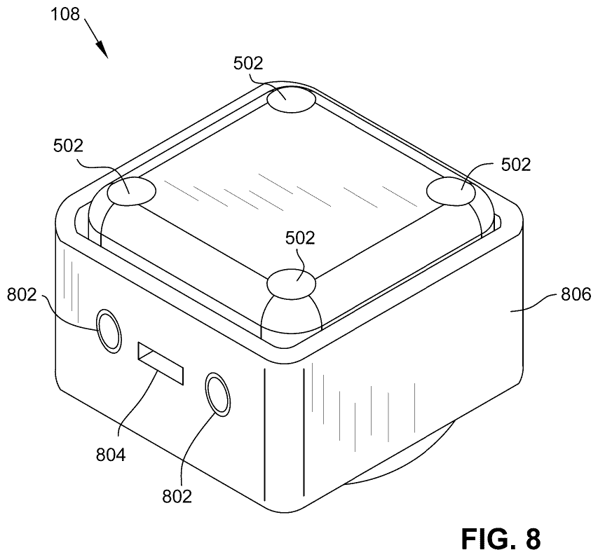

Referring now to FIG. 8, a perspective view of a CMD 108 of the cluster 100 of FIG. 1 is depicted according to at least one non-limiting aspect of the present disclosure. As previously discussed, the CMD 108 can include one or more propulsion systems 502. However, according to the non-limiting aspect of FIG. 8, the CMD 108 can include a specialized hull 806. For example, the hull 806 can be signal resistant and/or armored hull. In other words, the hull 806 can be include a material configured to reduce, block, or control electromagnetic signals. This can protect the CMD 108 from external interference or prevent its own signals from being detected or intercepted by an unauthorized third party. For example, the hull 806 can be produced from a metal composite, a carbon fiber composite, and/or a radar-absorbent materials. The hull 806 may further include a conductive coating or special mesh that can protect the CMD 108 from jamming, spoof attacks, or electromagnetic pulses. Alternately or additionally, the hull 806 can include a radiation hardened material to resist damage or prevent malfunctions caused by radiation. This can protect internal electronics from bit flipping, damaged transistors, or induced currents that can adversely effect operation of the CMD 108 and, therefore, the cluster 100 (FIGS. 1-5). According to some non-limiting aspects, the hull 806 can include a material configured to protect the CMD 108 from external perturbations, such as a kevlar, carbon fiber, ceramic, and/or an ablative material, amongst others. According to other non-limiting aspects, the hull 806 can include a multi-layer insulation and/or a reflective surface configured to shield the CMD 108 from visible and/or infrared detection.

Still referring to FIG. 8, the CMD 108 can further include one or more image sensors 802 for wide-angle imaging, such as a pinhole camera, a fisheye camera, or ultra-wide-angle optics. These sensors 802 can be low profile and may utilize a hard-to-detect form factor. Each image sensor 802 may be configured for a one-hundred-and-eighty degree field of view and, therefore, using two or more of such sensors 802 can enable the CMD 108 to have a three-hundred and sixty collective field-of-view for enhanced surveillance and situational awareness. According to some non-limiting aspects, image data generated by each of the image sensors 802 can be stitched together (e.g., via a control circuit of the CMD 108 or the CCA 302 (FIG. 3)) to create a composite view that covers a much larger area than a single image sensor 802. Such composite views of the cluster 100 (FIGS. 1-5) can be broadcast to the CCA 302 (FIG. 3). This can be particularly helpful in monitoring operation of other autonomous vehicles of the cluster 100 (FIGS. 1-5). For example, according to one non-limiting aspect, the image sensors 802 can be arranged (e.g., positioned on opposing sides of the CMD 802) to enable the CMD 108 to operate with full “spherical” awareness. This means the CMD 108 can perceive and monitor its entire surroundings in all directions, three-hundred-and-sixty degrees horizontally and one-hundred-and-eighty degrees vertically, forming a complete sphere of sensory coverage around the CMD 108. In other words, the CMD 108 can be outfitted with image sensors 802 specifically configured and arranged to enable the CMD 108 to generate sufficient image data, which it can use to generate a comprehensive characterization of the cluster 100 (FIGS. 1-5) and operating environment 101 (FIGS. 1 and 2), as necessary to execute the user-defined objective.

According to FIG. 8, the CMD 108 can further include one or more anchors 804 configured for mechanical engagement with the connective elements 116 (FIGS. 1, 2, 4, 5, 7A, and 7B). For example, the connective tether can be threaded through and secured to the one or more anchors 804 of the CMD 108. For example, the one or more anchors 804 can be dimensionally configured such that a blocking member (e.g., a head, a knot) of each connective elements 116 (FIGS. 1, 2, 4, 5, 7A, and 7B) cannot traverse through the one or more anchors 804. However, the connective elements 116 (FIGS. 1, 2, 4, 5, 7A, and 7B) can be constructed from a material that has a tensile strength that fails in response to tensions created by the CMD 108 upon activation of the propulsion systems 502. Accordingly, when the propulsion systems 502 are activated, the connective elements 116 (FIGS. 1, 2, 4, 5, 7A, and 7B) are severed and the CMD 108 can traverse the operating environment 101 (FIGS. 1 and 2) independent of the other autonomous vehicles of the cluster 100 (FIGS. 1-5).

According to other non-limiting aspects, the one or more anchors 804 of the CMD 108 of FIG. 8 can include a release mechanism, a portion of which may be contained within the hull 806 of the CMD 108. The connective elements 116 (FIGS. 1, 2, 4, 5, 7A, and 7B) may include a blocking member and the one or more anchors 804 can define a cavity configured to receive the blocking member when the blocking member is in a first orientation relative to the one or more anchors 804. However, the cavity of the anchor 804 may not be able to receive the blocking member when the blocking member is in a second orientation relative to the one or more anchors 804. Accordingly, the one or more anchors 804 can be configured to selectively prevent the connective element (FIGS. 1, 2, 4, 5, 7A, and 7B) from traversing through its cavity in the second orientation, such that the one or more anchors 804 retain the connective element (FIGS. 1, 2, 4, 5, 7A, and 7B). The release mechanism of the one or more anchors 804 can be configured to move the blocking member from the second orientation to the first orientation such that the connective element (FIGS. 1, 2, 4, 5, 7A, and 7B) can traverse through the anchor 804 and, therefore, can be released from the one or more anchors 804. Alternately, the release mechanism may be configured to completely remove or sever the blocking member from the connective element (FIGS. 1, 2, 4, 5, 7A, and 7B) such that the connective element (FIGS. 1, 2, 4, 5, 7A, and 7B) can traverse through the one or more anchors 804. The internal release member may be configured to utilize ordinance, a mechanism (e.g., a spring lock, a magnetic lock, etc.), an actuator (e.g., a servo-actuated pin or gate, etc.), and/or thermal energy (e.g., a burn wire, a heater, a laser, etc.) to release the connective element (FIGS. 1, 2, 4, 5, 7A, and 7B) from the anchor 804.

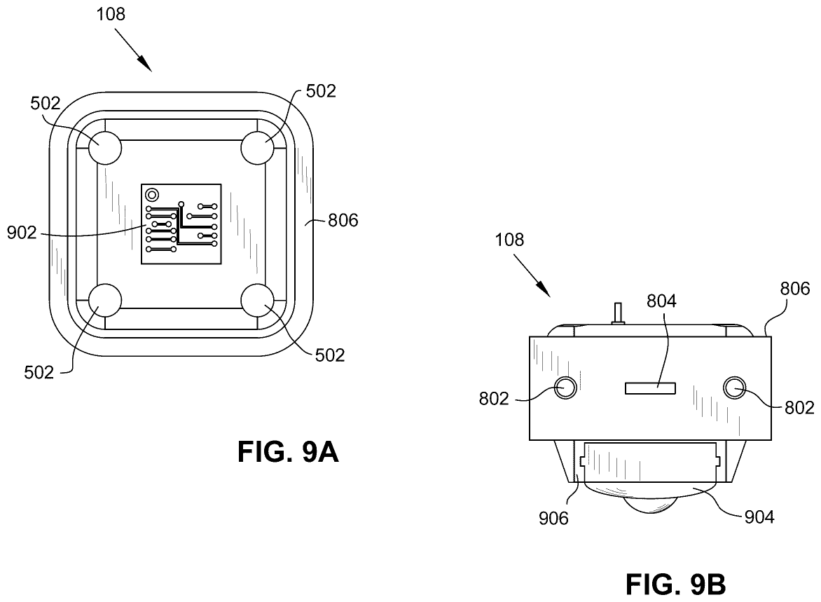

Referring now to FIGS. 9A and 9B, a top and side view of the CMD 108 of FIG. 8 are depicted according to at least one non-limiting aspect of the present disclosure. According to FIG. 9A, the CMD 108 can further include a communications circuit 902. The communications circuit 902 of the CMD 108 can be configured to facilitate not only intra-cluster 100 communications via the short range data network 111 (FIGS. 1-3) but also inter-cluster 100 communications or communications with the CCA 302 (FIG. 3) via the long range data network 308 (FIG. 3). Accordingly, it shall be appreciated that, relative to the MMDs 102_{a-f}, the communications circuit 902 of the CMD 108 can include increased capabilities. For example, the communications circuit 902 may be configured for multi-band or, at least, dual-band communications to facilitate the communications required of the CMD 108. The communications circuit 902 can be configured to switch between different communications layers and/or simultaneously transmit and receive signals via the different communications layers, depending on operational needs. The communications circuit 902 may include multiple receiver modules, at least one for short range communications and one for long range communications, a shared processing unit for protocol switching, data routing, encryption, and bandwidth prioritization and management, an antenna system (e.g., dipole antennas, 5 GHz, 2.4 GHz, L-band, S-band, Ka-band, etc.), and a power management circuit. The power management circuit may be configured to balance the very high power requirements of the long-range communications and the lower power requirements of the short-range communications.

In reference to FIG. 9B, the CMD 108 can further include a surveillance module 904. The surveillance module 904 can be configured for tactical reconnaissance, search-and-rescue, and/or target tracking on behalf of the cluster 100 (FIGS. 1-5). For example, the surveillance module 904 can include an infrared camera configured to detect heat-generating targets during night operations and/or adverse weather conditions. Accordingly, mage data generated by the surveillance module 904 can complement image data generated by the image sensors 802 (FIG. 8). However, according to other non-limiting aspects, the surveillance module 904 can include visible light and/or electro-optical cameras with higher zooms (e.g., thirty to sixty times), low-light sensors, global shutters, multi-spectral sensors, hyperspectral sensors, LiDAR modules, RADAR or synthetic aperture RADAR, acoustic or RF sensors, and/or optical zoom or ISR payload pods, amongst others). The surveillance module 904 can be configured for modular integration into the CMD 108 via a port 906 configured to electrically and mechanically couple the surveillance module 904 to the CMD 108. The surveillance module 904, therefore, may be one of a plurality of different payloads (e.g., visible light and/or electro-optical cameras with higher zooms (e.g., thirty to sixty times), low-light sensors, global shutters, multi-spectral sensors, hyperspectral sensors, LiDAR modules, RADAR or synthetic aperture RADAR, acoustic or RF sensors, optical zoom or ISR payload pods, etc.) configured for use with the CMD 108 and selected based on relevance to the user-defined objective. The port 906, therefore, can be universally configured to electrically and mechanically couple each of the plurality of different payloads to the CMD 108. However, according to some non-limiting aspects, the surveillance module 904 can be an integral or semi-permanent (welded, fastened, etc.) component of the CMD 108. It shall be appreciated that, due to the enhanced hull 806 and more capable communications circuit 902, the propulsion systems 502 of the CMD 108 may be more powerful (e.g., stronger motors, larger propellers, etc.) than the propulsion systems 502 of the MMDs 102_{a-f}.

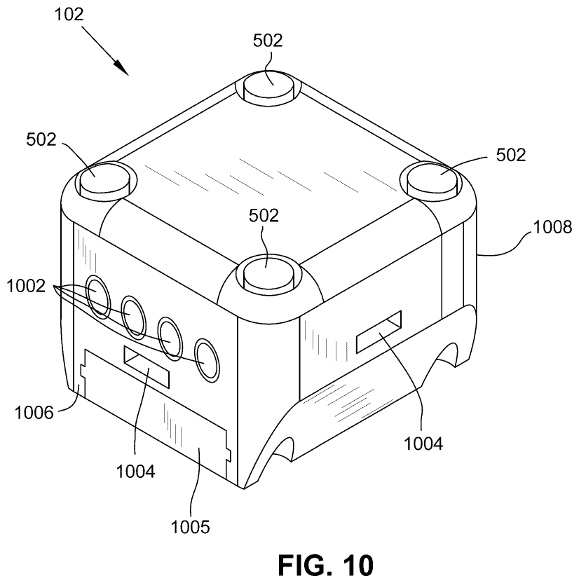

Referring now to FIG. 10, a perspective view of an MMD 102 of the cluster 100 of FIG. 1 is depicted according to at least one non-limiting aspect of the present disclosure. According to the non-limiting aspect of FIG. 10, the MMD 102 can include two or more propulsion systems 502 and one or more image sensors 1002, which can be tactically positioned to generate image data that enables functionality of the specific MMD 102. Although the image sensors 1002 of the MMD 102 may be the same types of sensors described in reference to the image sensors 802 (FIG. 8) of the CMD 108 (FIG. 8), they may be arranged and implemented to provide perspectives relevant to a specific task assigned to the MMD 102. For example, two or more image sensors 1002 may be positioned on a single side of the MMD 102 to provide a field of view that sufficiently encompasses operational field employed by a payload 1104 employed by the MMD 102. As depicted in FIG. 10, a hull 1008 of the MMD 102 may be less resilient or armored that the hull 806 (FIG. 8) of the CMD 108 (FIG. 8). However, similar to the port 906 (FIG. 9B) of the CMD 108 (FIG. 9B), the hull 1008 of the MMD 102 may define a port 1006 configured to electrically and mechanically couple the payload 1104 to the hull 1008 of the MMD 102. The MMD 102 may have one or more anchors 1004 configured similar to the anchors 804 (FIG. 8) of the CMD 108 (FIG. 8).

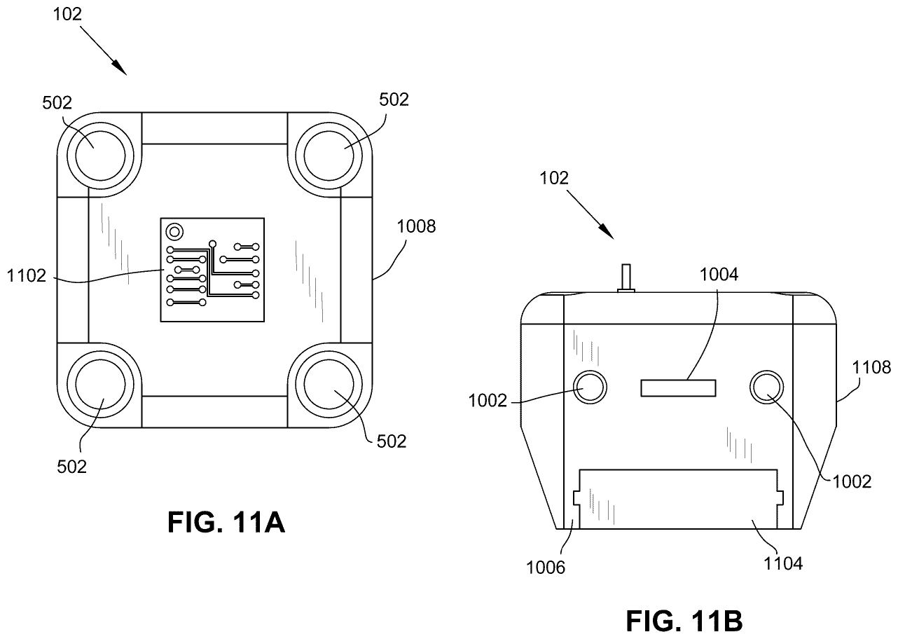

The aforementioned features of the MMD 102 are further illustrated in FIGS. 11A and 11B, which respectively depict a top and side view of the MMD 102 according to at least one non-limiting aspect of the present disclosure. However, as illustrated in FIGS. 11A and B, the MMD 102 can also include a communication circuit 1102. However, the communication circuit 1102 of the MMD 102 may only be configured for intra-cluster 100 (FIGS. 1-5) communications and, therefore, may only be configured to communicate via single-band (e.g., 2.4 GHz, 5.8 GHz, etc.) communications. In other words, the communication circuit 1102 of the MMD 102 facilitates communications via the short range data network 111 (e.g., Bluetooth, encrypted radio frequencies, Zigbee, direct line of sight communications, etc.). According to one non-limiting aspect, the communication circuit 102, therefore, can be configured to transmit or receive data to and from the CMDs 108 (FIG. 8) and/or other MMDs 102 of the cluster 100 (FIGS. 1-5) via a directional or omnidirectional antenna, a microcontroller or FPGA, and via modulation/demodulation hardware for encoding data via carrier waves.

According to FIG. 11B, the payload 1104 can be configured for modular integration into the MMD 102 via the port 1106, which can be configured to electrically and mechanically couple the payload 1104 to the MMD 102. The payload 1104, therefore, may be one of a plurality of different payloads configured for use with the MMD 102 and selected based on relevance to the user-defined objective. The port 1106, therefore, can be universally configured to electrically and mechanically couple each of the plurality of different payloads to the MMD 102. However, according to some non-limiting aspects, the payload 1104 can be an integral or semi-permanent (welded, fastened, etc.) component of the MMD 102.

As previously described the plurality of difference payloads configured for use with the MMD 102 and universally adapted for use with the port 1106 can include payloads for inspection, environmental monitoring, search and rescue, and mapping, LiDAR scanning for high-precision three-dimensional modeling, mapping, and environmental surveys, sprayers (e.g., liquid or powder) for agriculture, pest control, environmental restoration, or chemical distribution, robotic arms for performing tasks like picking up, moving, or assembling objects for repair, maintenance, or construction, GPS and navigation systems for accurate positioning, geolocation, and navigation, environmental sensors (e.g., air quality, gas detection, radiation) for monitoring pollution, hazardous materials, or unsafe conditions in industrial or natural environments, destructive payloads (e.g., kinetic, non-kinetic, gaseous, sonic, electricity-generating, radiation generating, injectable, etc.), RFID tags and/or scanners for inventory management, asset tracking, and logistics operations, sound or acoustic sensors for wildlife monitoring, search and rescue, and industrial inspections, payload delivery mechanisms, for delivering packages, cargo, medical suppliers, to hard-to-reach locations, sampling equipment, hyperspectral cameras for detecting chemical signatures or materials, magnetometers for geological surveys, mapping underground structures, or detecting ferrous objects, surveying tools (e.g., tool stations, laser scanners) for surveying, construction, urban planning, wind or weather sensors for real-time weather data collection, medical payloads (e.g., needles, defibrillators, first aid kits, etc.) for emergency medical response, ground penetrating radars for subsurface investigations, communication systems for transmissions to base stations, personnel, and/or other vehicles, communication relays and/or repeaters to extend communication ranges for large area operations to maintain connectivity, lights, lasers, or beacons for visibility in low-light conditions and signaling for navigation, cargo hooks and/or drop mechanisms for large payload deliveries, thermal desorption systems to remove volatile contaminants, autonomous landing systems for precision landings, amongst other payloads that can be mixed and matched to tailor the cluster 100 to accomplish a variety of different user-defined objectives.

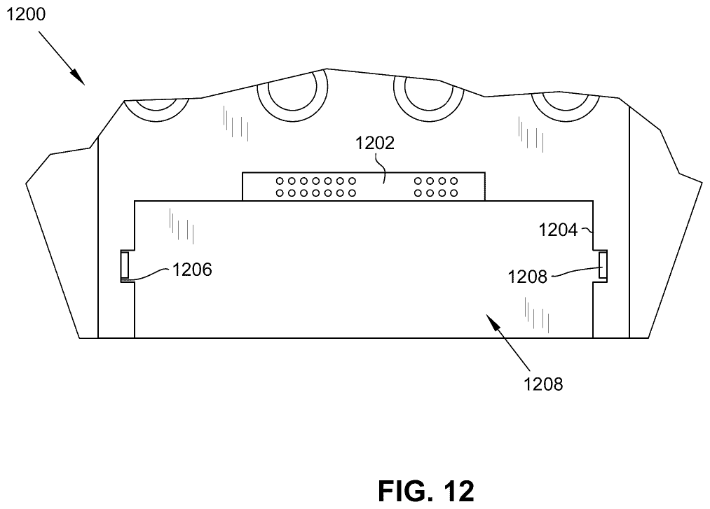

Referring now to FIG. 12, a port 1200 configured to mechanically and electrically couple any of a plurality of modular, interchangeable payloads to the vehicles of FIGS. 8 and 10 is depicted according to at least one non-limiting aspect of the present disclosure. The port 1200 is representative of the port 906 (FIG. 9B) of the CMD 108 (FIG. 9B) and the port of the 1106 (FIG. 11B) of the MMD 102 (FIG. 11B). According to the non-limiting aspect of FIG. 12, the port 1200 can include an electrical interface 1202, which can include one or more electrically conductive pins configured to convey power and/or data between a modular payload and the CMD 108 (FIG. 8) or the MMD 102 (FIG. 10). For example, the electrical interface 1202 can include a universal serial bus connector, a power of Ethernet connector, a magnetic connector, a Pixhawk connector, a PC104/PCIe Mini or M.2 connector, a SmartBatter SMbus, a UART connector, an I2C connector, an SPI connector, a CAN bus, a JST connector, an XT30/XT60/XT90 connector, a micro-fit or mini-fit connector, a pogo pin or spring contact, and/or a universal serial bus connector, amongst others.

From a mechanical perspective, the port 1200 of FIG. 12 can further include a cavity 1207 defined within the housing 806 (FIG. 8) of the CMD 108 (FIG. 8) or the hull 1008 (FIG. 10) of the MMD 102 (FIG. 10). The cavity 1207 can include a geometry that is substantially inverse relative to a geometry employed by each payload of a plurality of modular payloads configured for installation within the port 1200. In other words, the cavity 1207 can ensure that, when properly installed, a modular payload has a secure, mechanical fit within the housing 806 (FIG. 8) of the CMD 108 (FIG. 8) or the hull 1008 (FIG. 10) of the MMD 102 (FIG. 10). This can reduce unintended mechanical perturbations to an installed payload as the CMD 108 (FIG. 8) or MMD 102 (FIG. 10) traverses the operating environment 101 (FIGS. 1 and 2). However, the port can further include a first mechanical component 1204 and/or a second mechanical component 1206. The first mechanical component 1204 and the second mechanical component 1206 can include recesses of substantially inverse geometry to corresponding protrusions on each payload of the plurality of modular payloads.

As will be described in further detail herein, at least one of the corresponding protrusions on each payload of a plurality of modular payloads can be biased via a spring in an extended position, but depressed. Thus, the protrusions can be inserted within the first mechanical component 1204 and the second mechanical component 1206 and, therefore, each payload of a plurality of modular payloads can be secured within the 1208 of the CMD 108 (FIG. 8) or MMD 102 (FIG. 10). When properly secured within the 1208 of the CMD 108 (FIG. 8) or MMD 102 (FIG. 10), a corresponding electrical interface of each payload of a plurality of modular payloads can establish electrical contact with the electrical interface 1202 of the port 1200. Accordingly, a control circuit of the CMD 108 (FIG. 8) or MMD 102 (FIG. 10) can transmit signals and control the properly installed payload. As depicted in FIG. 12, at least the first mechanical component 1204 can include a button 1208 that, when electrically actuated or manually depressed from an exterior surface of the CMD 108 (FIG. 8) or MMD 102 (FIG. 10), can cause a corresponding protrusion of the installed payload to depress, which releases the payload from the port 1200, enabling a new payload of the plurality of modular payloads to be installed.

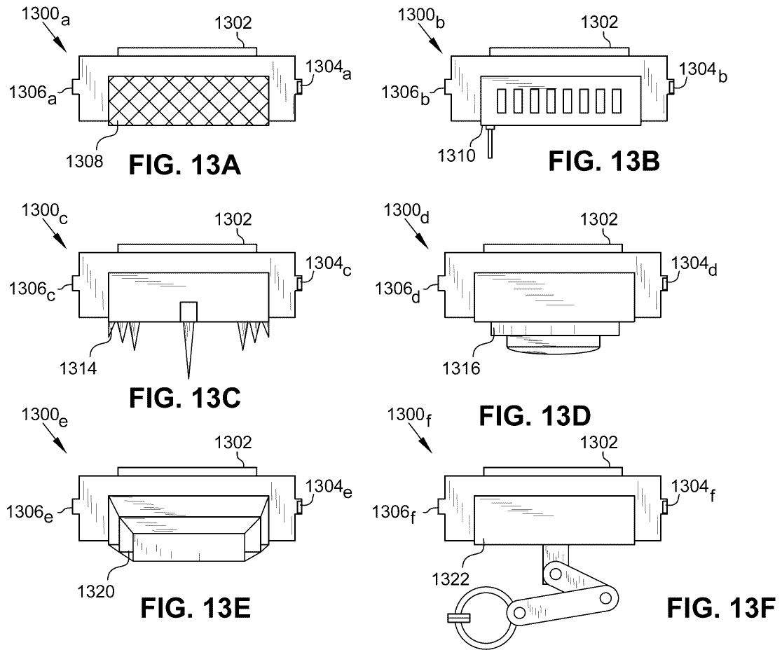

Referring now to FIGS. 13A-F, several modular, interchangeable payloads 1300_{a-f} configured for use with the port of FIG. 12 are depicted according to at least one non-limiting aspect of the present disclosure. The interchangeable payloads 1300_{a-f} of FIGS. 13A-F are merely non-limiting examples of payloads from the plurality of modular payloads contemplated herein. It shall be appreciated that any payload described herein but not depicted in FIGS. 13A-F can be similarly configured for use with the port of FIG. 12. For example, the each of the payloads 1300_{a-f} can include a first protrusion 1304ₐ₋ₑ and a second protrusion 1306ₐ₋ₑ. At least the first protrusion 1304ₐ₋ₑ can be spring biased into an extended position, as depicted in FIGS. 13A-F but configured to depressed in response to a manual and/or electronic input. When the first protrusion 1304ₐ₋ₑ is depressed, the second protrusion 1306ₐ₋ₑ can be installed into the corresponding second mechanical component 1206 (FIG. 12) of the port 1200. The body payload 1300_{a-f} can be subsequently inserted into the cavity 1207 of the port 1200 (FIG. 12) and, when the first protrusion 1304ₐ₋ₑ arrives at the first mechanical component 1204 (FIG. 12), the spring bias will case it to extend into the cavity of the first mechanical component 1204 (FIG. 12), securing the payload 1300_{a-f} within the cavity 1207 of the port 1200 (FIG. 12). Each payload 1300_{a-f} can further include an electrical interface 1302 with a pin configuration that corresponds to the electrical interface 1202 (FIG. 12) of the port 1200 (FIG. 12). Thus, when the payload 1300_{a-f} is properly secured within the cavity 1207 of the port 1200 (FIG. 12), the electrical interface 1302 of the payload 1300_{a-f} establishes electrical contact with the electrical interface 1202 (FIG. 12) of the port 1200 (FIG. 12).

According to FIG. 13A, a first payload 1300ₐ can include a kinetic payload that includes ordinance 1308 configured to be activated by the control circuit 104 of the MMD 102. The ordinance 1308 can be mechanically notched for standardized and/or controlled fragmentation. According to FIG. 13B, a second payload 1300_{b} can include a radio payload 1310 configured to be activated by the control circuit 104 of the MMD 102. The radio payload 1310 can be configured to generate magnetic interference and disrupt third-party radio transmissions and/or communications. According to FIG. 13C, a third payload 1300_{c} can include an injectable payload 1312 configured to be activated by the control circuit 104 of the MMD 102. The injectable payload 1312 configured for spring-based activation for sample injection or extraction. According to some non-limiting aspects, the third payload 1300_{c} can include one or more cleats 1314 configured to secure the third payload 1300_{c} to a target prior to injection or extraction. According to FIG. 13D, a fourth payload 1300_{d} can include an enhanced surveillance payload 1316 configured to be activated by the control circuit 104 of the MMD 102. The enhanced surveillance payload 1316 can be configured with additional, objective-specific sensing capabilities, including the visual and audible sensing devices disclosed herein. According to FIG. 13E, a fifth payload 1300ₑ can include a specialized payload 1320 configured to be activated by the control circuit 104 of the MMD 102. The specialized payload 1320 can be configured to perform any of the functions attributed to any of the other payloads described herein. However, according to some non-limiting aspects, the specialized payload 1320 can include, a fluid emission device, an electricity-generating device, ad/or a projectile device. The projectile, for example, can include a net, or any other projectile, such as a net, a cable or wire, a weighted chain, a foam or expanding polymer, a sticky substance, or fragmentation devices, such as pellets. According to some non-limiting aspects, the projectiles can be configured to capture or interfere with a target. According to FIG. 13F, a sixth payload 1300_{f} can include a robotic payload 1322 configured to be activated by the control circuit 104 of the MMD 102. The robotic payload 1322 can include one or more articulating joints and/or an end effector configured to open and close. For example, the robotic payload 1322 can be configured for three-dimensional articulation such that the end effector can interact with targets within the operating environment 101.

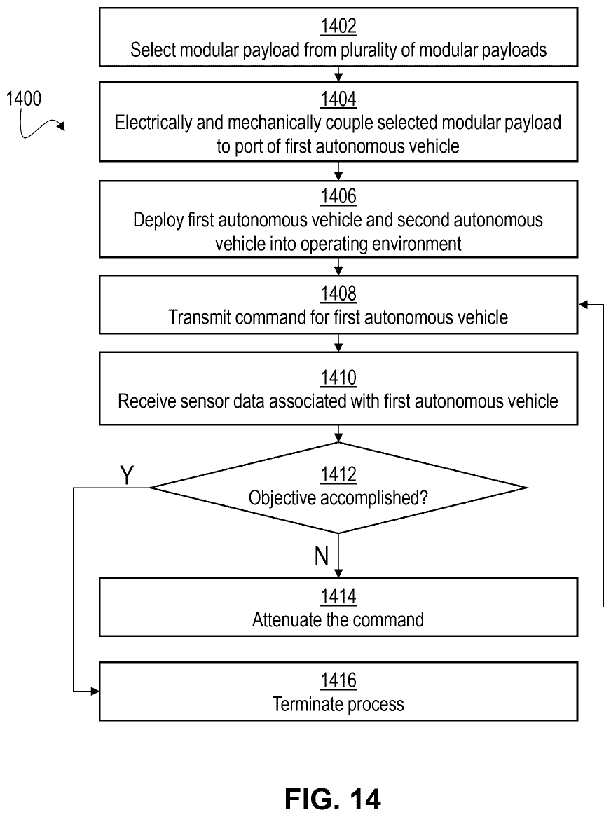

Referring now to FIG. 14, a method 1400 of executing a user-defined objective using the cluster 100 of autonomous vehicles of FIG. 1 is depicted according to at least one non-limiting aspect of the present disclosure. According to FIG. 14, the method 1400 can include selecting 1402 a modular payload from a plurality of modular payloads based on the user-defined objective. The method 1400 can further include electrically and mechanically coupling 1404 the modular payload selected from the plurality of modular payloads to a first autonomous vehicle via a port of the first autonomous vehicle and deploying 1406 the first autonomous vehicle and a second autonomous vehicle into an operating environment. The method 1400 can further include generating and transmitting 1408 a command for the first autonomous vehicle based on the user-defined objective and the modular payload selected from the plurality of modular payloads. For example, the command can be generated based on surveillance data generated by the second autonomous vehicle, data received from the first autonomous vehicle, and/or data received from a CCA.

Still referring to FIG. 14, the method 14 can further include transmitting the command from the second autonomous vehicle to the first autonomous vehicle via a short range data network that communicatively couples the first autonomous vehicle to the second autonomous vehicle. The command, for example, can be associated with an operation of the first autonomous vehicle and/or the modular payload selected from the plurality of modular payloads. According to some non-limiting aspects, the command can be generated via a CCA and transmitted to the second autonomous vehicle via a long range data network for subsequent transmission to the first autonomous vehicle via a short range data network. Having transmitted the command, the method 1400 can further include receiving 1410 sensor data associated with first autonomous vehicle and determining 1412 whether the user-defined objective has been accomplished based on the sensor data. The sensor data can be generated by the first autonomous vehicle, the second autonomous vehicle, or the CCA. If the objective has not been accomplished, the method 1400 can further include attenuating 1414 the command based on the received sensor data and again transmitting 1408 the attenuated command to the first autonomous vehicle, receiving 1410 sensor data, and determining 1412 if the objective has been accomplished. If the objective has been accomplished, the method 1400 can further include terminating 1416 the process.

Examples of the methods and systems disclosed herein, according to various aspects of the present disclosure, are provided below in the following embodiments. An aspect of the methods may include any one or more than one of, and any combination of, the embodiments described below.

Clause 1. A system for executing a user-defined objective, the system including a plurality of modular payloads and a plurality of autonomous vehicles configured to be deployed into an operating environment, wherein the plurality of autonomous vehicles includes a first autonomous vehicle including a port configured to electrically and mechanically couple each modular payload of the plurality of modular payloads to the first autonomous vehicle, and a second autonomous vehicle including a control circuit and a memory that stores instructions that, when executed by the control circuit, causes the second autonomous vehicle to establish communication with the first autonomous vehicle via a first data network generate surveillance data associated with the operating environment and the first autonomous vehicle, and transmit a command to the first autonomous vehicle via the first data network, wherein the command is associated with the user-defined objective and the surveillance data.

Clause 2. The system according to clause 1, wherein the plurality of modular payloads includes at least one of a robotic payload, a sensing payload, a chemical dispensing payload, a surveillance payload, a medical payload, a thermal dispersal payload, a kinetic payload, or combinations thereof.

Clause 3. The system according to either of clauses 1 or 2, further including a Command/Control Authority (“CCA”), and wherein, when executed by the control circuit, the instructions further cause the second autonomous vehicle to establish communication with the CCA via a second data network.

Clause 4. The system according to any of clauses 1-3, wherein the first data network includes a short range data network and wherein the second data network includes a long range data network.

Clause 5. The system according to any of clauses 1-4, wherein the CCA includes a control circuit and a memory that stores a a Modular Micro Cluster Drone (“MMCD”) model that, when executed by the control circuit, causes the CCA to receive the surveillance data from the second autonomous vehicle via the second data network, generate the command based on the user-defined objective and the surveillance data, and transmit the command to the second autonomous vehicle via the second data network.

Clause 6. The system according to any of clauses 1-5, wherein, when executed by the control circuit, the instructions further cause the generate the command based on the user-defined objective and the surveillance data.

Clause 7. The system according to any of clauses 1-6, wherein, when executed by the control circuit, the instructions further cause the second autonomous vehicle to transmit an attenuated command to the first autonomous vehicle via the first data network, wherein the attenuated command is associated with the user-defined objective and additional data.

Clause 8. The system according to any of clauses 1-7, wherein the additional data includes additional surveillance data generated by the second autonomous vehicle.

Clause 9. The system according to any of clauses 1-8, wherein the additional data includes data generated by the first autonomous vehicle and wherein, when executed by the control circuit, the instructions further cause the second autonomous vehicle to receive the additional data from the first autonomous vehicle via the first data network.

Clause 10. The system according to any of clauses 1-9, wherein the additional data includes data generated by a Command/Control Authority (“CCA”), and wherein, when executed by the control circuit, the instructions further cause the second autonomous vehicle to establish communication with the CCA via a second data network, and receive the additional data from the CCA via the second data network.

Clause 11. The system according to any of clauses 1-10, further including a housing, wherein the plurality of autonomous vehicles are configured to be contained within the housing, and wherein the plurality of autonomous vehicles are configured to be deployed from the housing into the operating environment.

Clause 12. The system according to any of clauses 1-11, wherein the housing includes a plurality of deployment mechanisms, wherein each deployment mechanism of the plurality of deployment mechanisms is configured to deploy an autonomous vehicle of the plurality of autonomous vehicles.

Clause 13. The system according to any of clauses 1-12, wherein the plurality of autonomous vehicles are mechanically coupled via a plurality of connective elements.

Clause 14. The system according to any of clauses 1-13, wherein the plurality of connective elements are configured to separate based on the plurality of autonomous vehicles being deployed into the operating environment.

Clause 15. A system for executing a user-defined objective, the system including a plurality of modular payloads, wherein each modular payload of the plurality of modular payloads includes a first geometry, and an autonomous vehicle including a port that defines a cavity including a second geometry inverse to the first geometry such that each modular payload of the plurality of modular payloads can be inserted within the cavity of the port, wherein the port includes an electrical interface configured to electrically couple each modular payload of the plurality of modular payloads to the autonomous vehicle when inserted within the cavity of the port, and wherein the port further includes a mechanical interface configured to secure each modular payload of the plurality of modular payloads to the autonomous vehicle when inserted within the cavity of the port.

Clause 16. The system according to clause 15, wherein the plurality of modular payloads includes at least one of a robotic payload, a sensing payload, a chemical dispensing payload, a surveillance payload, a medical payload, a thermal dispersal payload, a kinetic payload, or combinations thereof.

Clause 17. The system according to either of clauses 15 or 16, wherein each modular payload of the plurality of modular payloads includes a protrusion, and wherein the mechanical interface includes a recess configured to receive the protrusion when inserted within the cavity of the port.

Clause 18. The system according to any of clauses 15-17, wherein the protrusion is configured to transition between an extended position and a depressed position, wherein the protrusion is biased in the extended position, wherein each modular payload of the plurality of modular payloads can be inserted within the cavity of the port when the protrusion is in the depressed position, and wherein the recess of the mechanical interface is configured to allow the protrusion to be biased from the depressed position to the extended position when properly inserted within the cavity of the port.

Clause 19. The system according to any of clauses 15-18, wherein the mechanical interface further includes a button configured to overcome the bias and cause the protrusion to transition from the extended position to the depressed position for removal from the cavity of the port.

Clause 20. A method of executing a user-defined objective using a modular cluster of autonomous vehicles, the method including selecting a modular payload from a plurality of modular payloads based on the user-defined objective, electrically and mechanically coupled the modular payload selected from the plurality of modular payloads to a first autonomous vehicle via a port of the first autonomous vehicle, deploying the first autonomous vehicle and a second autonomous vehicle into an operating environment, generating a command for the first autonomous vehicle based on the user-defined objective and the modular payload selected from the plurality of modular payloads, and transmitting the command from the second autonomous vehicle to the first autonomous vehicle via a data network that communicatively couples the first autonomous vehicle to the second autonomous vehicle, wherein the command is associated with an operation of the modular payload selected from the plurality of modular payloads.

All patents, patent applications, publications, or other disclosure material mentioned herein, are hereby incorporated by reference in their entirety as if each individual reference was expressly incorporated by reference, respectively. All references, and any material, or portion thereof, that are said to be incorporated by reference herein are incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference and the disclosure expressly set forth in the present application controls.

The present invention has been described with reference to various exemplary and illustrative aspects. The aspects described herein are understood as providing illustrative features of varying detail of various aspects of the disclosed invention; and therefore, unless otherwise specified, it is to be understood that, to the extent possible, one or more features, elements, components, constituents, ingredients, structures, modules, and/or aspects of the disclosed aspects may be combined, separated, interchanged, and/or rearranged with or relative to one or more other features, elements, components, constituents, ingredients, structures, modules, and/or aspects of the disclosed aspects without departing from the scope of the disclosed invention. Accordingly, it will be recognized by persons having ordinary skill in the art that various substitutions, modifications, or combinations of any of the exemplary aspects may be made without departing from the scope of the invention. In addition, persons skilled in the art will recognize, or be able to ascertain using no more than routine experimentation, many equivalents to the various aspects of the invention described herein upon review of this specification. Thus, the invention is not limited by the description of the various aspects, but rather by the claims.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may be performed in any order. Also, although claim recitations are presented in a sequence(s), it should be understood that the various operations may be performed in other orders than those which are described or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a,” “an,” and “the” include the plural references unless the context clearly dictates otherwise.

Directional phrases used herein, such as, for example and without limitation, top, bottom, left, right, lower, upper, front, back, and variations thereof, shall relate to the orientation of the elements shown in the accompanying drawing and are not limiting upon the claims unless otherwise expressly stated.

The terms “about” or “approximately” as used in the present disclosure, unless otherwise specified, means an acceptable error for a particular value as determined by one of ordinary skill in the art, which depends in part on how the value is measured or determined. In certain aspects, the term “about” or “approximately” means within 1, 2, 3, or 4 standard deviations. In certain aspects, the term “about” or “approximately” means within 50%, 200%, 105%, 100%, 9%, 8%, 7%, 6%, 5%, 4%, 3%, 2%, 1%, 0.5%, or 0.05% of a given value or range.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 100” includes all sub-ranges between (and including) the recited minimum value of 1 and the recited maximum value of 100, that is, having a minimum value equal to or greater than 1 and a maximum value equal to or less than 100. Also, all ranges recited herein are inclusive of the end points of the recited ranges. For example, a range of “1 to 100” includes the end points 1 and 100. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system that “comprises,” “has,” “includes” or “contains” one or more elements possesses those one or more elements but is not limited to possessing only those one or more elements. Likewise, an element of a system, device, or apparatus that “comprises,” “has,” “includes” or “contains” one or more features possesses those one or more features but is not limited to possessing only those one or more features.

Instructions used to program logic to perform various disclosed aspects can be stored within a memory in the system, such as dynamic random-access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random-access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor including one or more individual instruction processing cores, processing unit, processor, microcontroller, microcontroller unit, controller, digital signal processor (DSP), programmable logic device (PLD), programmable logic array (PLA), or field programmable gate array (FPGA)), state machine circuitry, firmware that stores instructions executed by programmable circuitry, and any combination thereof. The control circuit may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Accordingly, as used herein “control circuit” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microcontroller configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware, and/or circuitry configured to perform any of the aforementioned operations. Software may be embodied as a software package, code, instructions, instruction sets and/or data recorded on non-transitory computer readable storage medium. Firmware may be embodied as code, instructions or instructions sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard,” published in December 2008 and/or later versions of this standard. Alternatively, or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively, or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively, or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different, and/or after-developed connection-oriented network communication protocols are equally contemplated herein.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can encompass active-state components and/or inactive-state components and/or standby-state components unless context requires otherwise.

The terms “proximal” and “distal” are used herein with reference to a clinician manipulating the handle portion of the surgical instrument. The term “proximal” refers to the portion closest to the clinician and the term “distal” refers to the portion located away from the clinician. It will be further appreciated that, for convenience and clarity, spatial terms such as “vertical,” “horizontal,” “up,” and “down” may be used herein with respect to the drawings. However, surgical instruments are used in many orientations and positions, and these terms are not intended to be limiting and/or absolute.

What is claimed is:

1. A system for executing a user-defined objective, the system comprising:
a plurality of modular payloads; and
a plurality of autonomous vehicles configured to be deployed into an operating environment, wherein the plurality of autonomous vehicles comprises:
a first autonomous vehicle comprising a port configured to electrically and mechanically couple each modular payload of the plurality of modular payloads to the first autonomous vehicle; and
a second autonomous vehicle comprising a control circuit and a memory that stores instructions that, when executed by the control circuit, causes the second autonomous vehicle to:
establish communication with the first autonomous vehicle via a first data network;
generate surveillance data associated with the operating environment and the first autonomous vehicle; and
transmit a command to the first autonomous vehicle via the first data network, wherein the command is associated with the user-defined objective and the surveillance data.

2. The system of claim 1, wherein the plurality of modular payloads comprises at least one of a robotic payload, a sensing payload, a chemical dispensing payload, a surveillance payload, a medical payload, a thermal dispersal payload, a kinetic payload, or combinations thereof.

3. The system of claim 1, further comprising a Command/Control Authority (“CCA”), and wherein, when executed by the control circuit, the instructions further cause the second autonomous vehicle to establish communication with the CCA via a second data network.

4. The system of claim 3, wherein the first data network comprises a short range data network and wherein the second data network comprises a long range data network.

5. The system of claim 3, wherein the CCA comprises a control circuit and a memory that stores a a Modular Micro Cluster Drone (“MMCD”) model that, when executed by the control circuit, causes the CCA to:
receive the surveillance data from the second autonomous vehicle via the second data network;
generate the command based on the user-defined objective and the surveillance data; and
transmit the command to the second autonomous vehicle via the second data network.

6. The system of claim 1, wherein, when executed by the control circuit, the instructions further cause the generate the command based on the user-defined objective and the surveillance data.

7. The system of claim 1, wherein, when executed by the control circuit, the instructions further cause the second autonomous vehicle to:
transmit an attenuated command to the first autonomous vehicle via the first data network, wherein the attenuated command is associated with the user-defined objective and additional data.

8. The system of claim 7, wherein the additional data comprises additional surveillance data generated by the second autonomous vehicle.

9. The system of claim 7, wherein the additional data comprises data generated by the first autonomous vehicle and wherein, when executed by the control circuit, the instructions further cause the second autonomous vehicle to:
receive the additional data from the first autonomous vehicle via the first data network.

10. The system of claim 7, wherein the additional data comprises data generated by a Command/Control Authority (“CCA”), and wherein, when executed by the control circuit, the instructions further cause the second autonomous vehicle to:
establish communication with the CCA via a second data network; and
receive the additional data from the CCA via the second data network.

11. The system of claim 1, further comprising:
a housing, wherein the plurality of autonomous vehicles are configured to be contained within the housing, and wherein the plurality of autonomous vehicles are configured to be deployed from the housing into the operating environment.

12. The system of claim 11, wherein the housing comprises a plurality of deployment mechanisms, wherein each deployment mechanism of the plurality of deployment mechanisms is configured to deploy an autonomous vehicle of the plurality of autonomous vehicles.

13. The system of claim 1, wherein the plurality of autonomous vehicles are mechanically coupled via a plurality of connective elements.

14. The system of claim 13, wherein the plurality of connective elements are configured to separate based on the plurality of autonomous vehicles being deployed into the operating environment.

15. A system for executing a user-defined objective, the system comprising:
a plurality of modular payloads, wherein each modular payload of the plurality of modular payloads comprises a first geometry; and
an autonomous vehicle comprising a port that defines a cavity comprising a second geometry inverse to the first geometry such that each modular payload of the plurality of modular payloads can be inserted within the cavity of the port, wherein the port comprises an electrical interface configured to electrically couple each modular payload of the plurality of modular payloads to the autonomous vehicle when inserted within the cavity of the port, and wherein the port further comprises a mechanical interface configured to secure each modular payload of the plurality of modular payloads to the autonomous vehicle when inserted within the cavity of the port.

16. The system of claim 15, wherein the plurality of modular payloads comprises at least one of a robotic payload, a sensing payload, a chemical dispensing payload, a surveillance payload, a medical payload, a thermal dispersal payload, a kinetic payload, or combinations thereof.

17. The system of claim 15, wherein each modular payload of the plurality of modular payloads comprises a protrusion, and wherein the mechanical interface comprises a recess configured to receive the protrusion when inserted within the cavity of the port.

18. The system of claim 17, wherein the protrusion is configured to transition between an extended position and a depressed position, wherein the protrusion is biased in the extended position, wherein each modular payload of the plurality of modular payloads can be inserted within the cavity of the port when the protrusion is in the depressed position, and wherein the recess of the mechanical interface is configured to allow the protrusion to be biased from the depressed position to the extended position when properly inserted within the cavity of the port.

19. The system of claim 18, wherein the mechanical interface further comprises a button configured to overcome the bias and cause the protrusion to transition from the extended position to the depressed position for removal from the cavity of the port.

20. A method of executing a user-defined objective using a modular cluster of autonomous vehicles, the method comprising:
selecting a modular payload from a plurality of modular payloads based on the user-defined objective;
electrically and mechanically coupled the modular payload selected from the plurality of modular payloads to a first autonomous vehicle via a port of the first autonomous vehicle;
deploying the first autonomous vehicle and a second autonomous vehicle into an operating environment;
generating a command for the first autonomous vehicle based on the user-defined objective and the modular payload selected from the plurality of modular payloads; and
transmitting the command from the second autonomous vehicle to the first autonomous vehicle via a data network that communicatively couples the first autonomous vehicle to the second autonomous vehicle, wherein the command is associated with an operation of the modular payload selected from the plurality of modular payloads.
